(19) United States
(12) Patent Application Publication
(10) Pub. No.: US 2026/0343371 A1
(43) Pub. Date: Oct. 29, 2026

(54) CONDITIONAL HANDOVER WITH A TARGET DUAL CONNECTIVITY CONFIGURATION

(71) Applicant: Nokia Technologies Oy, Espoo (FI)

(72) Inventors: Ahmad AWADA, Munich (DE); Halit Murat GÜRSU, Munich (DE); Umur KARABULUT, Munich (DE); Panagiotis SPAPIS, Munich (DE); Srinivasan SELVAGANAPATHY, Bangalore (IN); Subramanya CHANDRASHEKAR, Bangalore (IN); Jedrzej STANCZAK, Wroclaw (PL)

(21) Appl. No.: 19/099,063

(22) PCT Filed: Jun. 5, 2023
(86) PCT No.: PCT/EP2023/064945

§ 371 Date: Jan. 28, 2025

(30) Foreign Application Priority Data
Jul. 28, 2022 (IN) 202241043264

(51) Int. Cl. H04W 36/36; H04W 36/00

(52) U.S. Cl. CPC H04W 36/362; H04W 36/0069; H04W 36/00835; H04W 36/0085

(57) ABSTRACT

An apparatus comprising; at least one processor; and at least one memory including computer program code, the at least one memory storing instructions that, when executed by the at least one processor, cause the apparatus at least to: establish a connection towards a user equipment, UE, via a source primary cell; provide the UE a source primary cell measurement configuration; determine a condition to access a target primary cell of a secondary cell group of a target secondary node associated with a conditional handover towards a target master node; generate a measurement identity to be associated, in an updated source primary cell measurement configuration, with the condition to access the target primary cell of a secondary cell group of a target secondary node associated with a conditional handover towards a target master node; including, in an updated source primary cell measurement configuration, the generated measurement identity and the condition to access the target primary cell of the secondary cell group; transmit the updated source primary cell measurement configuration to the user equipment.

### TECHNOLOGICAL FIELD

Examples of the disclosure relate to conditional handover. Some relate to conditional handover with dual connectivity configuration.

### BACKGROUND

A wireless network comprises a plurality of network nodes including terminal nodes and access nodes. Communication between the terminal nodes and access nodes is wireless.

In some circumstances it may be desirable to improve or enhance conditional handover with a target dual connectivity configuration.

### BRIEF SUMMARY

According to various, but not necessarily all, embodiments there is provided an apparatus comprising;
at least one processor; and
at least one memory including computer program code,
the at least one memory storing instructions that, when executed by the at least one processor, cause the apparatus at least to:
establish a connection towards a user equipment, UE, via a source primary cell;
provide the UE a source primary cell measurement configuration;
determine a condition to access a target primary cell of a secondary cell group of a target secondary node associated with a conditional handover towards a target master node;
generate a measurement identity to be associated, in an updated source primary cell measurement configuration, with the condition to access the target primary cell of a secondary cell group of a target secondary node associated with a conditional handover towards a target master node;
including, in an updated source primary cell measurement configuration, the generated measurement identity and the condition to access the target primary cell of the secondary cell group;
transmit the updated source primary cell measurement configuration to the user equipment.

In some examples, determining the condition to access the target primary cell of the secondary cell group comprises receiving information and determining the condition based, at least in part, on the received information.

In some examples, the information is received from a target master node and comprises measurement related information.

In some examples, the measurement related information comprises measurement object information.

In some examples, the at least one memory storing instructions that, when executed by the at least one processor, cause the apparatus at least to generate a reporting configuration of the condition to access the target primary cell of the secondary cell group.

In some examples, the condition comprises a conditional PSCell addition and change, CPAC, condition.

In some examples, the updated source primary cell measurement configuration comprises the generated measurement identity and the measurement object information received from the target master node.

In some examples, the updated source primary cell measurement configuration comprises the generated reporting configuration.

In some examples, determining the condition to access the target primary cell of the secondary cell group comprises receiving the condition.

In some examples, the at least one memory storing instructions that, when executed by the at least one processor, cause the apparatus at least to receive a reporting configuration of the condition to access the target primary cell of the secondary cell group.

In some example, the updated source primary cell measurement configuration comprises a conditional handover, CHO, execution condition.

In some examples, the updated source primary cell measurement configuration comprises a first CHO execution condition and a first condition to access a target primary cell of a secondary cell group associated with a first generated measurement identity and a second CHO execution condition and a second condition to access a target primary cell of a secondary cell group associated with a second generated measurement identity, wherein the first and second conditions to access a target primary cell of a secondary cell group comprise conditional PSCell addition and change, CPAC, conditions.

In some examples, the at least one memory storing instructions that, when executed by the at least one processor, cause the apparatus at least to:
receive an indication of a second measurement identity associated, in a target primary cell measurement configuration, with the condition to access the target primary cell of the secondary cell group; and
transmit, to the UE, an indication to maintain, after application of the target primary cell measurement configuration, measurement information associated with evaluation of the condition to access the target primary cell of a secondary cell group that is associated with the generated measurement identity, for evaluation of the condition to access the target primary cell of a secondary cell group that is associated with the second measurement identity.

In some examples, the indication of the second measurement identity comprises the second measurement identity.

According to various, but not necessarily all, embodiments there is provided a method comprising:
establishing a connection towards a user equipment, UE, via a source primary cell;
providing the UE a source primary cell measurement configuration;
determining a condition to access a target primary cell of a secondary cell group of a target secondary node associated with a conditional handover towards a master node;
generating a measurement identity to be associated, in an updated source primary cell measurement configuration, with the condition to access the target primary cell of a secondary cell group of a target secondary node associated with a conditional handover towards a target master node;
include, in an updated source primary cell measurement configuration, the generated measurement identity and the condition to access the target primary cell of the secondary cell group;
transmitting the updated source primary cell measurement configuration to the user equipment.

In some examples, determining the condition to access the target primary cell of the secondary cell group comprises receiving information and determining the condition based, at least in part, on the received information.

In some examples, determining the condition to access the target primary cell of the secondary cell group comprises receiving the condition.

In some examples, the method comprises:
receiving an indication of a second measurement identity associated, in a target primary cell measurement configuration, with the condition to access the target primary cell of the secondary cell group; and
transmitting, to the UE, an indication to maintain, after application of the target primary cell measurement configuration, measurement information associated with evaluation of the condition to access the target primary cell of a secondary cell group that is associated with the generated measurement identity, for evaluation of the condition to access the target primary cell of a secondary cell group that is associated with the second measurement identity.

According to various, but not necessarily all, embodiments there is provided a computer program comprising instructions for causing an apparatus to perform at least the following:
establishing a connection towards a user equipment, UE, via a source primary cell;
providing the UE a source primary cell measurement configuration;
determining a condition to access a target primary cell of a secondary cell group of a target secondary node associated with a conditional handover towards a target master node;
generating a measurement identity to be associated, in an updated source primary cell measurement configuration, with the condition to access the target primary cell of a secondary cell group of a target secondary node associated with a conditional handover towards a target master node;
including, in an updated source primary cell measurement configuration, the generated measurement identity and the condition to access the target primary cell of the secondary cell group;
transmitting the updated source primary cell measurement configuration to the user equipment.

In some examples, determining the condition to access the target primary cell of the secondary cell group comprises receiving information and determining the condition based, at least in part, on the received information.

In some examples, determining the condition to access the target primary cell of the secondary cell group comprises receiving the condition.

In some examples, the computer program comprising instructions for causing an apparatus to perform at least the following:
receiving an indication of a second measurement identity associated, in a target primary cell measurement configuration, with the condition to access the target primary cell of the secondary cell group; and
transmitting, to the UE, an indication to maintain, after application of the target primary cell measurement configuration, measurement information associated with evaluation of the condition to access the target primary cell of a secondary cell group that is associated with the generated measurement identity, for evaluation of the condition to access the target primary cell of a secondary cell group that is associated with the second measurement identity.

According to various, but not necessarily all, embodiments there is provided an apparatus comprising;
at least one processor; and
at least one memory including computer program code,
the at least one memory storing instructions that, when executed by the at least one processor, cause the apparatus at least to:
receive a handover request; and
transmit information to allow a determination of a condition to access a target primary cell of a secondary cell group of a target secondary node associated with a conditional handover towards a target master node to be associated in a source primary cell measurement configuration with a measurement identity generated by a source master node.

In some examples, the at least one memory storing instructions that, when executed by the at least one processor, cause the apparatus at least to:
determine the condition to access a target primary cell of a secondary cell group and
wherein transmitting information to allow a determination of a condition to access a target primary cell of a secondary cell group comprises transmitting the determined condition.

In some examples, the information comprises measurement related information.

In some examples, the measurement related information comprises measurement object information.

In some examples, the at least one memory storing instructions that, when executed by the at least one processor, cause the apparatus at least to determine a reporting configuration of the condition to access the target primary cell of the secondary cell group and wherein transmitting information to allow a determination of a condition to access a target primary cell of a secondary cell group comprises transmitting the determined reporting configuration.

In some examples, the at least one memory storing instructions that, when executed by the at least one processor, cause the apparatus at least to:
transmit an indication of a measurement identity associated, in a target primary cell measurement configuration, with the condition to access the target primary cell of a secondary cell group.

In some examples, the indication of the measurement identity comprises the measurement identity associated, in a target primary cell measurement configuration, with the condition to access the target primary cell of a secondary cell group.

According to various, but not necessarily all, embodiments there is provided a method comprising;
receiving a handover request; and
transmitting information to allow a determination of a condition to access a target primary cell of a secondary cell group of a target secondary node associated with a conditional handover towards a target master node to be associated in a source primary cell measurement configuration with a measurement identity generated by a source master node.

In some examples, the method comprises:
determining the condition to access a target primary cell of a secondary cell group and
wherein transmitting information to allow a determination of a condition to access a target primary cell of a secondary cell group comprises transmitting the determined condition.

In some examples, the method comprises:
transmitting an indication of a measurement identity associated, in a target primary cell measurement configuration, with the condition to access the target primary cell of a secondary cell group.

According to various, but not necessarily all, embodiments there is provided a computer program comprising instructions for causing an apparatus to perform at least the following:
receiving a handover request; and
transmitting information to allow a determination of a condition to access a target primary cell of a secondary cell group of a target secondary node associated with a conditional handover towards a target master node to be associated in a source primary cell measurement configuration with a measurement identity generated by a source master node.

In some examples, the computer program comprising instructions for causing an apparatus to perform at least the following:
determining the condition to access a target primary cell of a secondary cell group and
wherein transmitting information to allow a determination of a condition to access a target primary cell of a secondary cell group comprises transmitting the determined condition.

In some examples, the computer program comprising instructions for causing an apparatus to perform at least the following:
transmitting an indication of a measurement identity associated, in a target primary cell measurement configuration, with the condition to access the target primary cell of a secondary cell group.

According to various, but not necessarily all, embodiments there is provided an apparatus comprising;
at least one processor; and
at least one memory including computer program code,
the at least one memory storing instructions that, when executed by the at least one processor, cause the apparatus at least to:
establish a connection towards a source master node;
receive, from the source master node, at least one measurement configuration containing a condition to access a target primary cell of a secondary cell group of a target secondary node associated with a conditional handover towards a target master node; and
create at least one measurement variable for the received at least one measurement configuration.

In some examples, the at least one measurement configuration is a source primary cell measurement configuration.

In some examples, creating at least one measurement variable for the received at least one measurement configuration comprises updating at least one measurement variable associated with a source primary cell to include a measurement identity associated with the condition to access a target primary cell of a secondary cell group.

In some examples, the at least one memory storing instructions that, when executed by the at least one processor, cause the apparatus at least to:
receive an indication to maintain, after application of a target primary cell measurement configuration, measurement information associated with the condition to access the target primary cell of a secondary cell group that is associated with the measurement identity, for evaluation of the condition to access the target primary cell of a secondary cell group that is associated with a second measurement identity in the target primary cell measurement configuration.

In some examples, the indication comprises the second measurement identity.

In some examples, the at least one memory storing instructions that, when executed by the at least one processor, cause the apparatus at least to use the maintained measurement information for evaluation of the condition to access the target primary cell of a secondary cell group that is associated with the second measurement identity in the target primary cell measurement configuration.

In some examples, the at least one measurement configuration comprises a target primary cell measurement configuration.

In some examples, creating the at least one measurement variable comprises creating at least one independent measurement variable for the target primary cell measurement configuration.

In some examples, the at least one memory storing instructions that, when executed by the at least one processor, cause the apparatus at least to:
receive an indication to maintain, after application of the target primary cell measurement configuration, measurement information for evaluation of the condition to access a target primary cell of a secondary cell group.

In some examples, the indication comprises a flag.

In some examples, the at least one memory storing instructions that, when executed by the at least one processor, cause the apparatus at least to use the maintained measurement information for evaluation of the condition to access the target primary cell of a secondary cell group after application of the target primary cell measurement configuration.

According to various, but not necessarily all, embodiments there is provided a method comprising:
establishing a connection towards a source master node;
receiving, from the source master node, at least one measurement configuration containing a condition to access a target primary cell of a secondary cell group of a target secondary node associated with a conditional handover towards a target master node; and
creating at least one measurement variable for the received at least one measurement configuration.

In some examples, the at least one measurement configuration is a source primary cell measurement configuration.

In some examples, creating at least one measurement variable for the received at least one measurement configuration comprises updating at least one measurement variable associated with a source primary cell to include a measurement identity associated with the condition to access a target primary cell of a secondary cell group.

In some examples, the method comprises:
receiving an indication to maintain, after application of a target primary cell measurement configuration, measurement information associated with the condition to access the target primary cell of a secondary cell group that is associated with the measurement identity, for evaluation of the condition to access the target primary cell of a secondary cell group that is associated with a second measurement identity in the target primary cell measurement configuration.

In some examples, the indication comprises the second measurement identity.

In some examples, the at least one measurement configuration comprises a target primary cell measurement configuration.

In some examples, creating the at least one measurement variable comprises creating at least one independent measurement variable for the target primary cell measurement configuration.

In some examples, the method comprises:
receiving an indication to maintain, after application of the target primary cell measurement configuration, measurement information for evaluation of the condition to access a target primary cell of a secondary cell group.

In some examples, the indication comprises an indication of a measurement identity associated with the condition to access a target primary cell of a secondary cell group in the target primary cell measurement configuration.

According to various, but not necessarily all, embodiments there is provided a computer program comprising instructions for causing an apparatus to perform at least the following:
establishing a connection towards a source master node;
receiving, from the source master node, at least one measurement configuration containing a condition to access a target primary cell of a secondary cell group of a target secondary node associated with a conditional handover towards a target master node; and
creating at least one measurement variable for the received at least one measurement configuration.

In some examples, the at least one measurement configuration is a source primary cell measurement configuration.

In some examples, creating at least one measurement variable for the received at least one measurement configuration comprises updating at least one measurement variable associated with a source primary cell to include a measurement identity associated with the condition to access a target primary cell of a secondary cell group.

In some examples, the computer program comprising instructions for causing an apparatus to perform at least the following:
receiving an indication to maintain, after application of a target primary cell measurement configuration, measurement information associated with the condition to access the target primary cell of a secondary cell group that is associated with the measurement identity, for evaluation of the condition to access the target primary cell of a secondary cell group that is associated with a second measurement identity in the target primary cell measurement configuration.

In some examples, the indication comprises the second measurement identity.

In some examples, the at least one measurement configuration comprises a target primary cell measurement configuration.

In some examples, creating the at least one measurement variable comprises creating at least one independent measurement variable for the target primary cell measurement configuration.

In some examples, the computer program comprising instructions for causing an apparatus to perform at least the following:
receiving an indication to maintain, after application of the target primary cell measurement configuration, measurement information for evaluation of the condition to access a target primary cell of a secondary cell group.

In some examples, the indication comprises an indication of a measurement identity associated with the condition to access a target primary cell of a secondary cell group in the target primary cell measurement configuration.

According to various, but not necessarily all, embodiments there is provided an apparatus comprising;
at least one processor; and
at least one memory including computer program code,
the at least one memory storing instructions that, when executed by the at least one processor, cause the apparatus at least to:
receive a handover request; and
determine a condition to access a target primary cell of a secondary cell group of a target secondary node associated with a conditional handover towards a target master node;
generate a measurement identity to be associated, in a target primary cell measurement configuration, with the condition to access a target primary cell of a secondary cell group;
including the generated measurement identity and determined condition in a target primary cell measurement configuration;
transmitting the target primary cell measurement configuration to a source master node; and
transmitting an indication to maintain, after application of the target primary cell measurement configuration, measurement information for evaluation of the condition to access a target primary cell of a secondary cell group.

In some examples, the indication comprises a flag.

In some examples, the indication comprises an indication to maintain, after conditional handover, CHO, execution, measurement information for evaluation of the condition to access a target primary cell of a secondary cell group.

According to various, but not necessarily all, embodiments there is provided an apparatus comprising;
at least one processor; and
at least one memory including computer program code,
the at least one memory storing instructions that, when executed by the at least one processor, cause the apparatus at least to:
receiving, from a target master node, a target primary cell measurement configuration including a measurement identity and condition to access a target primary cell of a secondary cell group of a target secondary node associated with a conditional handover towards the target master node;
receiving an indication to maintain, after application of the target primary cell measurement configuration, measurement information for evaluation of the condition to access a target primary cell of a secondary cell group; and
transmitting the target primary cell measurement configuration and indication to a user equipment.

In some examples, the indication comprises a flag.

According to various, but not necessarily all, embodiments there is provided an apparatus comprising;
at least one processor; and
at least one memory including computer program code,
the at least one memory storing instructions that, when executed by the at least one processor, cause the apparatus at least to perform at least a part of one or more methods disclosed herein.

According to various, but not necessarily all, embodiments there is provided an apparatus comprising means for performing at least part of one or more methods disclosed herein.

According to various, but not necessarily all, examples there is provided examples as claimed in the appended claims.

The description of a function should additionally be considered to also disclose any means suitable for performing that function.

### BRIEF DESCRIPTION

Some examples will now be described with reference to the accompanying drawings in which:

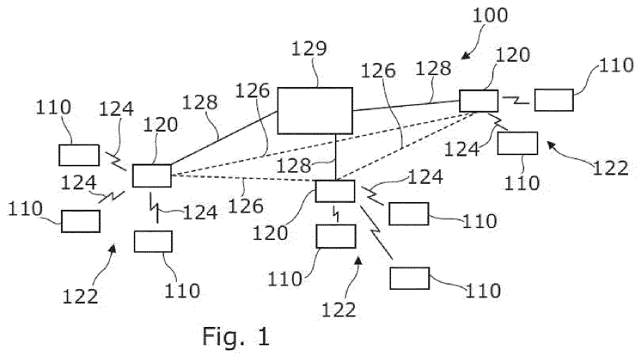

FIG. 1 shows an example of the subject matter described herein;

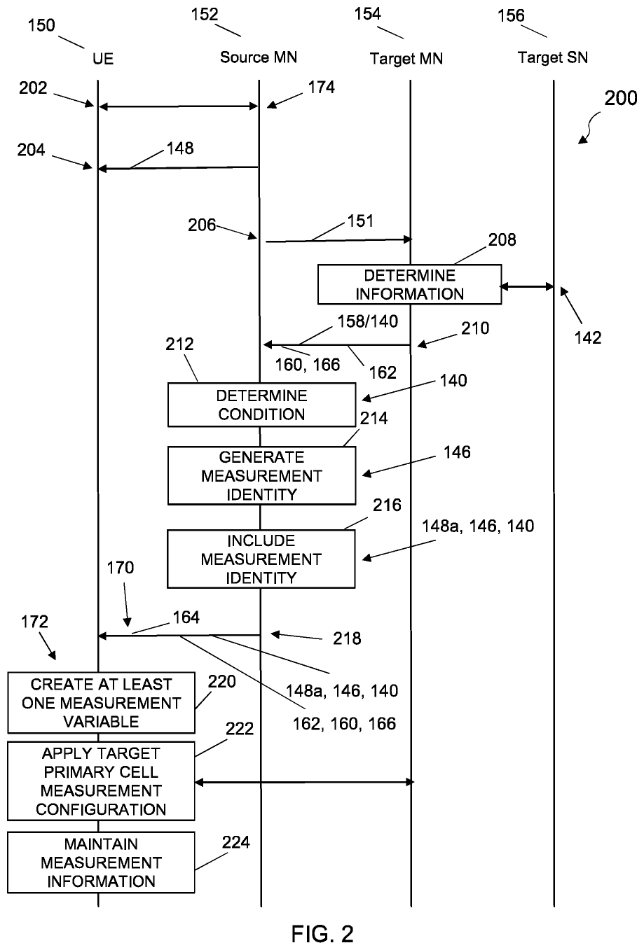

FIG. 2 shows another example of the subject matter described herein;

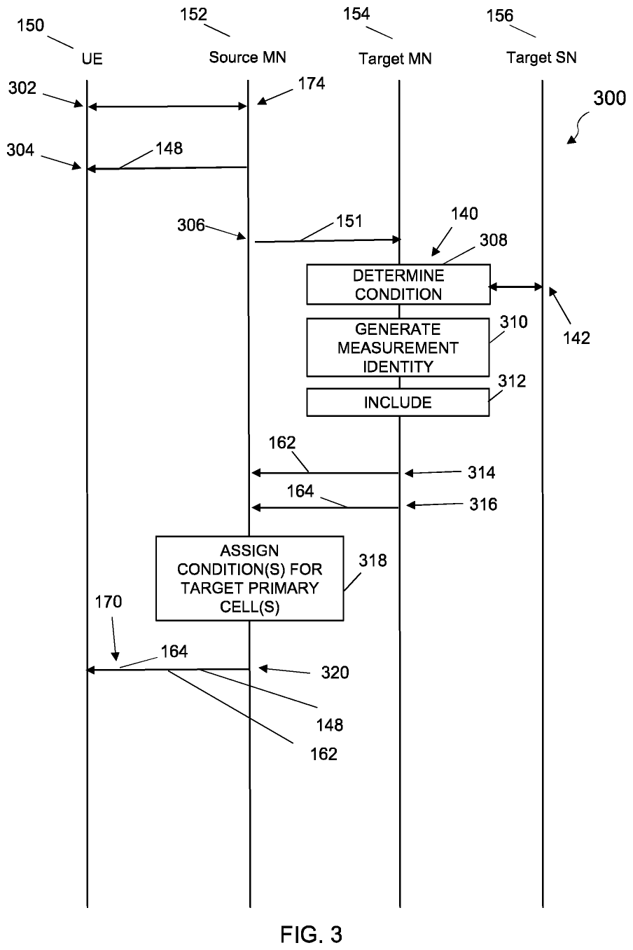

FIG. 3 shows another example of the subject matter described herein;

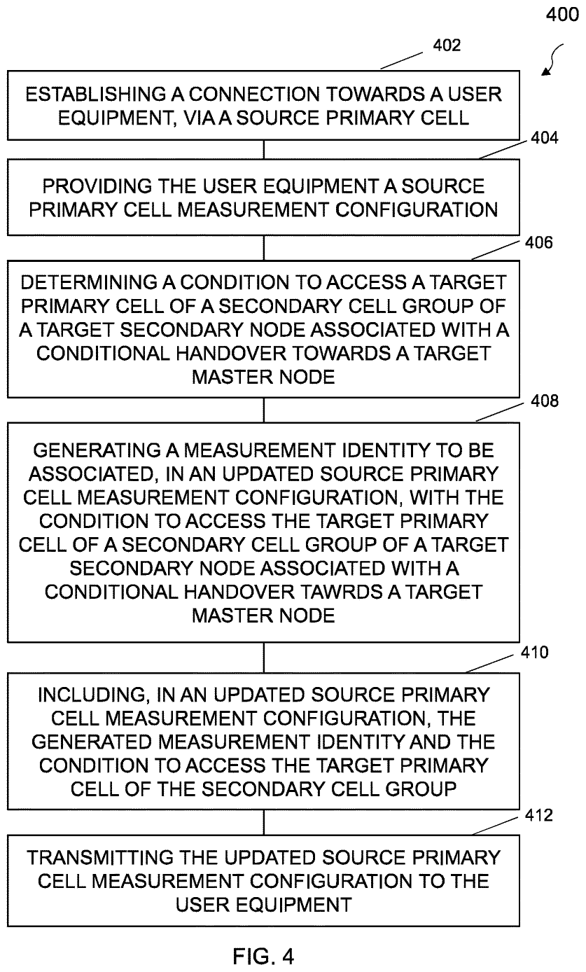

FIG. 4 shows another example of the subject matter described herein;

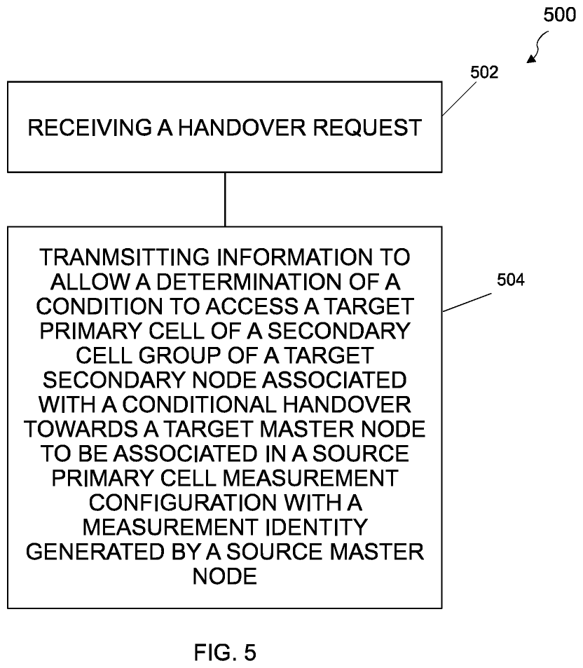

FIG. 5 shows another example of the subject matter described herein;

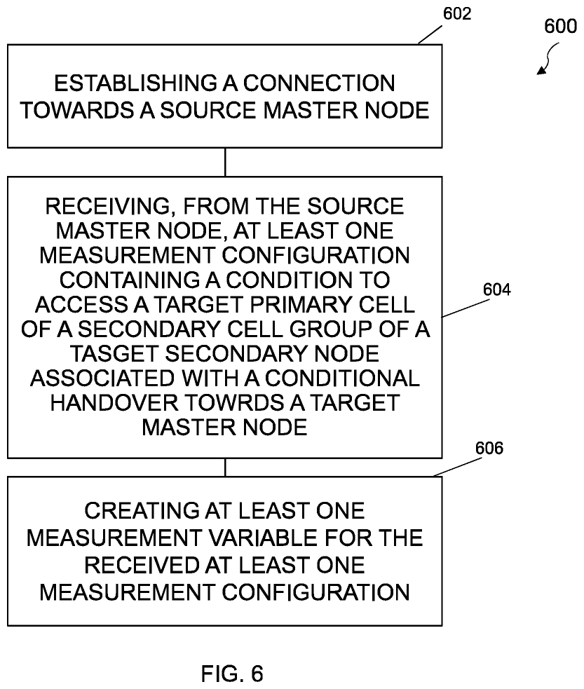

FIG. 6 shows another example of the subject matter described herein;

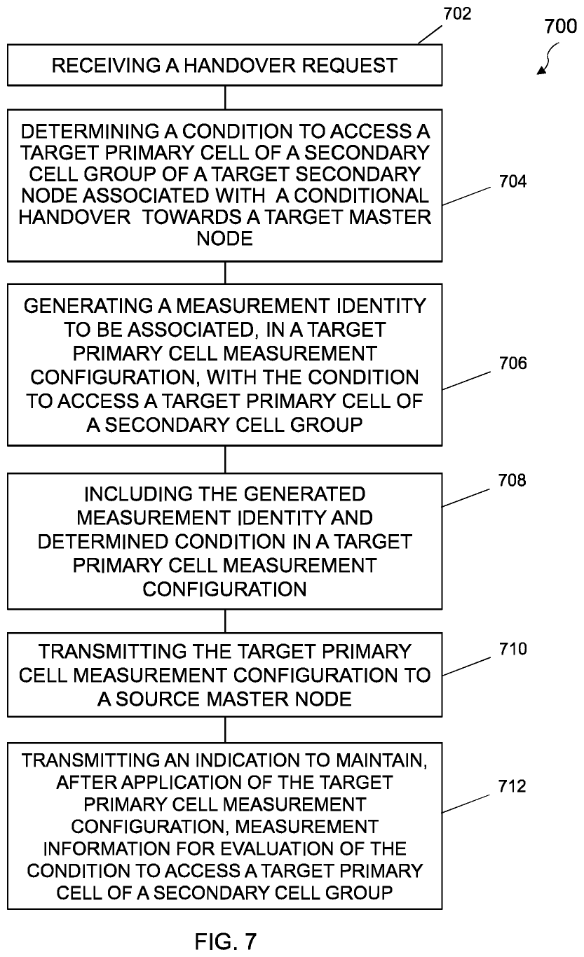

FIG. 7 shows another example of the subject matter described herein;

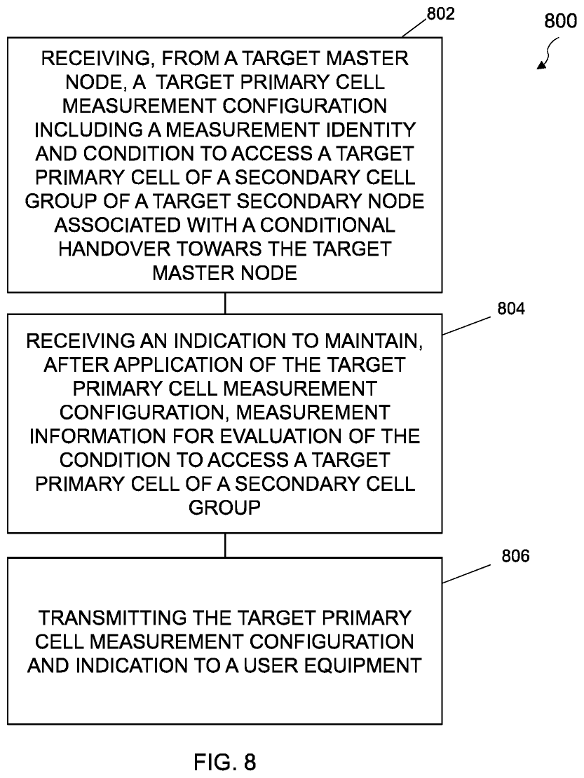

FIG. 8 shows another example of the subject matter described herein;

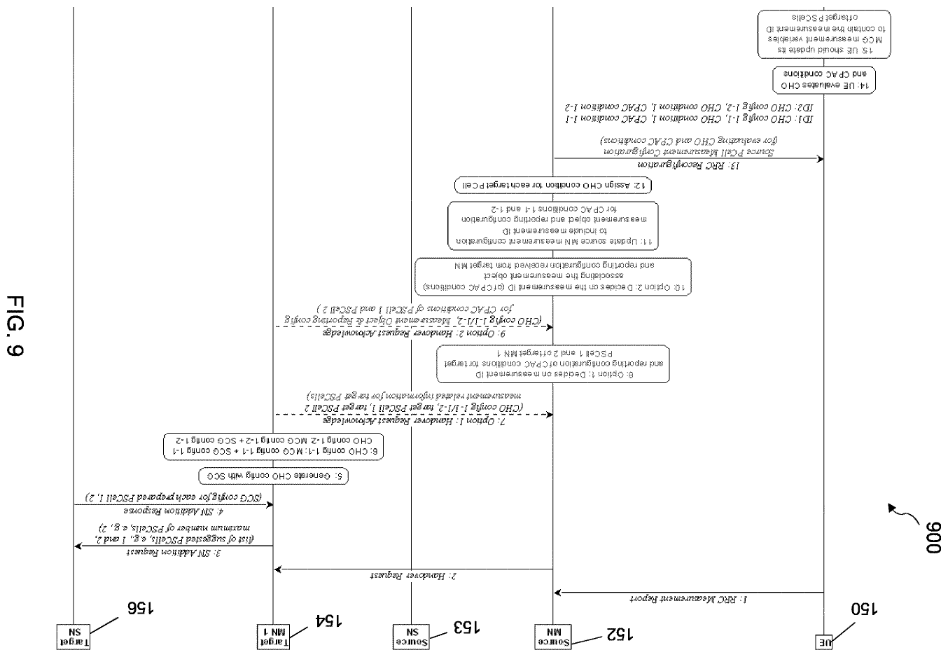

FIG. 9 shows another example of the subject matter described herein;

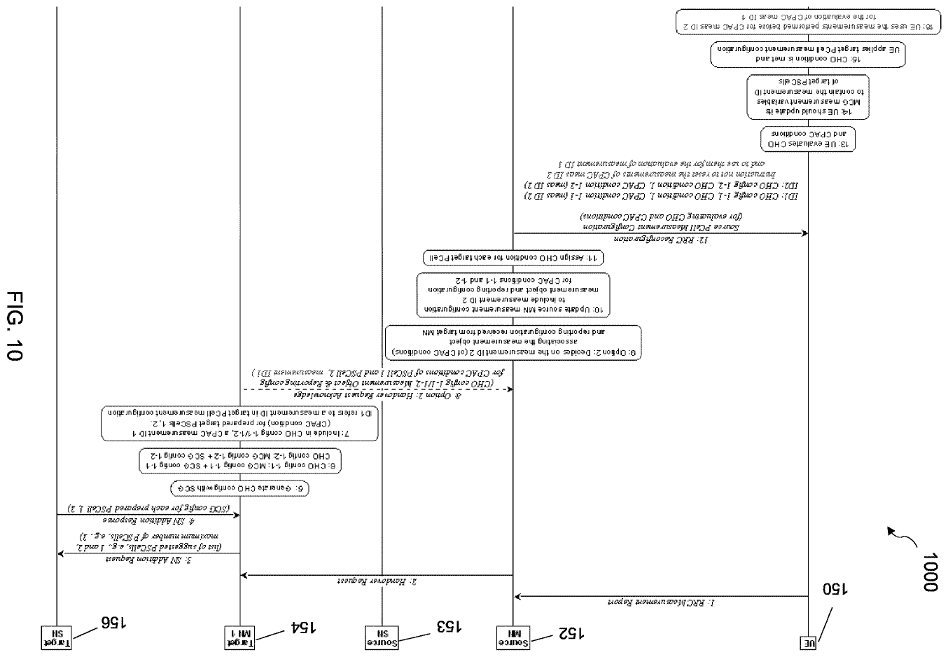

FIG. 10 shows another example of the subject matter described herein;

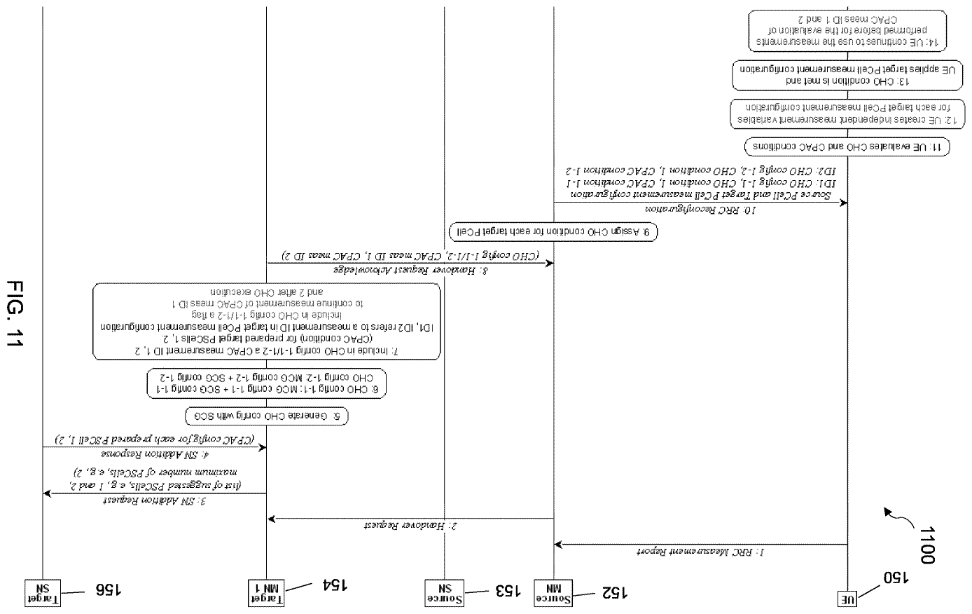

FIG. 11 shows another example of the subject matter described herein;

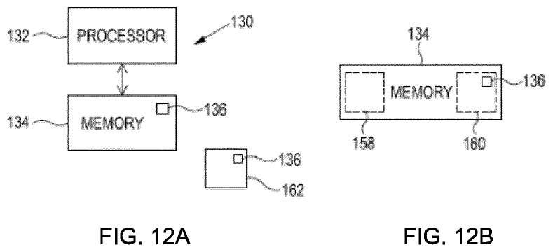

FIG. 12A shows another example of the subject matter described herein; and

FIG. 12B shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DEFINITIONS

Master Node (MN): Network node that provides control plane connectivity towards the core network.

Master Cell Group (MCG): Group of cells associated with the MN, includes PCell and SCell(s).

Secondary Node (SN): Network node that is providing additional radio resources for the UE but is not the MN.

### Secondary Cell Group (SCG): Group of Cells Associated With the Sn, Includes PSCell and SCell(s).

PCell: The cell for uplink/downlink connection to MN. Cell of MCG used to initiate initial access to the MN.

PSCell: the cell for uplink/downlink connection to SN. Cell of SCG used to initiate initial access to the SN.

Conditional Handover (CHO)—a handover procedure that is triggered by the UE only when the configured execution condition(s) are met for a prepared candidate cell. Condition(s) are pre-configured by network. In 3GPP, a conditional handover execution condition is specified by condExecutionCond within the CondReconfigToAddModList information element within the ConditionalReconfiguration information element within an RRCReconfiguration message.

### Dual Connectivity (DC:

UE has contemporaneous connection to an MN and an SN. This is a mode of operation of a UE in RRC_CONNECTED, configured with a Master Cell Group and a Secondary Cell Group.

### Configuration Information:

Information used to configure operation of a UE. In 3GPP, the configuration information can, for example, be provided in an RRCReconfiguration message. The term “configuration information comprising” an entity (for example handover execution condition for a primary cell; SN addition condition for dual connectivity with the primary cell and so on) can mean that the configuration information comprises information sufficient to obtain the entity. It may or may not comprise all parameters of the entity, it may instead comprise pointer to the entity or parameters of the entity or can mean that configuration includes the entity.

In 3GPP, a RRCReconfiguration message specifies a ConditionalReconfiguration information element which provides addition conditions for the DC. The ConditionalReconfiguration information element comprises a CondReconfigToAddModList information element. The CondReconfig ToAddModList information element comprises condExecutionCond and condRRCReconfig. Addition condition(s) for a primary secondary cell (PSCell) are specified by condExecutionCond. The RRCReconfiguration message to be applied when the specified conditions are met is provided by condRRCReconfig.

### Measurement Configuration

Configuration information used to configure a UE to perform measurement(s). In 3GPP, the measurement configuration can, for example, be provided in an RRCReconfiguration message. The term “[entity] measurement configuration” (for example source primary cell measurement configuration) can mean a measurement configuration prepared by the entity.

Can comprise one or more measurement objects and one or more reporting configurations associated by one or more measurement identities.

Can comprise a MeasConfig information element as defined in TS 38.331.

### Measurement Object

Defines one or more objects that the UE is to measure, for example carrier frequency. Can include a list of cells (for example white and black lists) that the UE should consider for measurement and/or frequency-/cell-specific parameters that are used in measurement events, for example frequency-specific offset of the frequency of the neighbouring cell and/or the cell specific offset of the neighbour cell.

### Report Configuration

Defines the configuration of the measurement report that the UE sends to the network. Indicates the measurement quantity, for example received signal received power (RSRP) and/or reference signal received quality (RSRQ) and whether the measurement should, for example, be reported periodically or based on a measurement event. In the latter case, the configuration can specify the event(s) that shall be used, for example A3 event, and their corresponding parameters such as Time to Trigger, hysteresis and so on. Conditional handover to a master node and/or secondary node can be configured in a report configuration, for example conditional handover (CHO) condition and/or conditional PSCell addition and change (CPAC) condition.

### Measurement Identity (ID)

An identifier that can be associated with a condition to access a cell such as a primary cell of a secondary cell group. Can be an identifier that associates a measurement object with a reporting configuration in a measurement configuration.

### Measurement Variables

IN DC, the UE can receive two independent measurement configurations from source MN and SN. For each measurement configuration, the UE maintains, at least, two measurement variables VarMeasConfig and VarMeasReportList. The UE variable VarMeasConfig includes the accumulated configuration of the measurements to be performed by the UE covering intra-frequency, inter-frequency and inter-RAT mobility measurements. The UE variable VarMeasReportList includes information about the measurements for which the triggering conditions have been met.

### DETAILED DESCRIPTION

FIG. 1 illustrates an example of a network 100 comprising a plurality of network nodes including terminal nodes 110, access nodes 120 and one or more core nodes 129. The terminal nodes 110 and access nodes 120 communicate with each other. The one or more core nodes 129 communicate with the access nodes 120.

The network 100 is in this example a radio telecommunications network, in which at least some of the terminal nodes 110 and access nodes 120 communicate with each other using transmission/reception of radio waves/signals.

The one or more core nodes 129 may, in some examples, communicate with each other. The one or more access nodes 120 may, in some examples, communicate with each other.

The network 100 may be a cellular network comprising a plurality of cells 122 each served by an access node 120. In this example, the interface between the terminal nodes 110 and an access node 120 defining a cell 122 is a wireless interface 124.

The access node 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) and the access nodes 120 are base stations.

In examples the network 100 is an Evolved Universal Terrestrial Radio Access network (E-UTRAN). The E-UTRAN consists of E-UTRAN NodeBs (eNBs) 120, providing the E-UTRA user plane and control plane (RRC) protocol terminations towards the UE 110. The eNBs 120 are interconnected with each other by means of an X2 interface 126. The eNBs are also connected by means of the S1 interface 128 to the Mobility Management Entity (MME) 129.

In other example the network 100 is a Next Generation (or New Radio, NR) Radio Access network (NG-RAN). The NG-RAN consists of gNodeBs (gNBs) 120, providing the user plane and control plane (RRC) protocol terminations towards the UE 110. The gNBs 120 are interconnected with each other by means of an Xn interface 126. The gNBs are also connected by means of the N2 interface 128 to the Access and Mobility management Function (AMF).

In examples, the network 100 can comprise a combination of E-UTRAN and NG-RAN.

A user equipment comprises a mobile equipment. Where reference is made to user equipment that reference includes and encompasses, wherever possible, a reference to mobile equipment.

A UE 150 can perform a handover procedure to change the serving cell of the UE 150. In examples, a handover procedure can be a conditional handover procedure.

A conditional handover (CHO) procedure can be considered a handover that is triggered by the UE 150 when one or more handover execution conditions are met. The handover execution condition or conditions can be pre-configured by the network 100.

In examples, the UE 150 starts evaluating the execution condition(s) for CHO candidate cells upon receiving a CHO configuration, and executes the handover command once the execution condition(s) are met for a CHO candidate cell. The UE 150 may stop evaluating the execution condition(s) for other candidate cells once the execution condition(s) are met for a candidate cell.

In examples, a UE 150 can be provided with additional radio resources using dual connectivity (DC).

In DC, the configured set of serving cells for a UE 150 has two subsets: the Master Cell Group (MCG) containing the serving cells of a Master Node (MN) 152, and the Secondary Cell Group (SCG) containing the serving cells of a Secondary Node (SN) 153.

In examples, a conditional handover with dual connectivity can be configured. A UE 150 can be configured with execution condition(s) for CHO to one or more target MN 154 and execution condition(s) for handover to one or more target SN 156.

In examples, a terminal node 110, such as a UE 150, can be configured to efficiently manage and can efficiently manage measurement information during a conditional handover.

FIG. 2 illustrates an example of a method 200.

In examples, FIG. 2 can be considered to illustrate a plurality of methods. For example, FIG. 2 illustrates one or more actions at a plurality of actors/entities. In examples, FIG. 2 can be considered to illustrate a plurality of methods performed by the individual actors/entities.

One or more of the features discussed in relation to FIG. 2 can be found in one or more of the other FIGS.

In the example of FIG. 2, a plurality of apparatuses transmit and/or receive one or more signals and/or one or more messages across and/or via and/or using a network. In examples, any suitable form of communication in any suitable network can be used. For example, at least a portion of the network 100 of FIG. 1 can be used.

Accordingly, in examples, the plurality of apparatuses in FIG. 2 form at least a portion of a network 100 as described in relation to FIG. 1.

In the illustrated example, a terminal node 110, and three access nodes 120 transmit and/or receive one or more signals and/or one or more messages. In the example of FIG. 2 the terminal node 110 is a UE 150 and the three access nodes 120 are a source MN 152, a target MN 154, and a target SN 156.

In examples (not illustrated in FIG. 2) the UE 150 can also be connected to a source SN.

In examples, communications and/or transmissions between elements illustrated in FIG. 2 can proceed via any number of intervening elements, including no intervening elements.

Although one UE 150 is illustrated in the example of FIG. 2, in examples any suitable number of UEs 150 can be included.

Similarly, in examples, any suitable number of network nodes can be included.

In examples, method 200 and/or parts of method 200 can be considered a method of enhancing conditional handover.

In examples, method 200 and/or one or more parts of method 200 can be considered a method of enhancing conditional handover with dual connectivity.

In examples, method 200 and/or one or more parts of method 200 can be considered a method of handling measurement variables.

In examples, method 200 and/or one or more parts of method 200 can be considered a method of handling UE measurement information.

In the illustrated example, the location of the blocks indicates the entity performing the action(s). For example, block 212 is performed at/by the source MN 152.

At block 202, method 200 comprises, from the point of view of the source MN 152, establishing a connection towards a user equipment, UE 150, via a source primary cell 174 (Pcell of source MN 152).

In some examples, the source MN 152 can be considered a source MN 152 when the connection towards the UE has been established.

From the point of view of the UE 150, block 202 comprises establishing a connection towards a source master node 152.

This is illustrated, in the example of FIG. 2, by the double headed arrow between the UE 150 and source MN 152.

Accordingly, it can be considered that block 202 comprises establishing a connection between a UE 150 and a source MN 152.

Establishing a connection can be performed in any suitable way, using any suitable method.

In some examples, establishing a connection comprises establishing an active radio link.

In some examples, establishing a connection comprises transmitting and/or receiving one or more signals.

In some examples, establishing a connection comprises performing a random access procedure. For example, the UE 150 can perform a random access process with the source MN 152 to establish a connection towards the source MN 152.

Establishing a connection between the ue 150 and source mn 152 can, for example, result in
direct access of the UE 150 to the source MN 152;
establishment of a radio link between the UE 150 and the source MN 152/source primary cell 174 that enables the transfer of data via uplink (UL) and/or downlink (DL). The radio link can, for example, be established by initiating a RACH procedure at the UE 150;
traffic flow via bearer between the UE 150 and the network via source MN 152/source primary cell 174.

At block 204, method 200 comprises providing the UE 150 a source primary cell measurement configuration 148.

In examples, block 204 can be considered to comprise transmitting a source primary cell measurement configuration 148 to the UE 150.

As FIG. 2 illustrates one or more actions of transmission, for example, of one or more signals, FIG. 2 also illustrates the corresponding transmitting/causing transmission feature(s)/action(s).

Similarly, for any transmitting/causing transmission feature(s)/action(s), FIG. 2 also illustrates the corresponding receiving/causing receiving feature(s)/action(s).

For example, from the point of view of the source MN 152, block 204 can be considered to illustrate providing the UE 150 a source primary cell measurement configuration 148.

Similarly, from the point of view of the UE 150, block 204 can be considered to illustrate receiving a source primary cell measurement configuration 148.

Providing the UE 150 a source primary cell measurement configuration 148 can be performed in any suitable way using any suitable method.

In examples, providing the UE 150 a source primary cell measurement configuration 148 comprises transmitting/receiving one or more signals and/or messages.

At block 206, method 200 comprises, from the point of view of the target MN 154, receiving a handover request 151. Accordingly, from the point of view of the source MN 152, block 206 illustrates transmitting a handover request 151.

The handover request 151 can have any suitable form and can be transmitted in any suitable way using any suitable method.

In examples, receiving the handover request 151 comprises receiving one or more signals and/or messages.

Receiving the handover request 151 can comprise receiving a Handover Request message.

The handover request 151 can comprise any suitable information. In examples, the handover request 151 comprises information to request the target MN 154 to prepare for handover of a connection with a UE 150.

In some examples, the handover request indicates that a conditional handover is to be configured.

At block 208, method 200 comprises determining information 158 to allow a determination of a condition 140 to access a target primary cell of a secondary cell group 142 (PSCell) of a target secondary node 156 associated with a conditional handover towards a target master node 154.

In examples, the condition 140 is to be associated in a source primary cell measurement configuration 148 with a measurement identity 146 generated by a source master node 152.

The information 158 can be determined any suitable way.

As used herein, the term “determining” (and grammatical variants thereof) can include, not least: calculating, computing, processing, deriving, investigating, looking up (for example, looking up in a table, a database or another data structure), ascertaining and the like. Also, “determining” can include receiving (for example, receiving information), accessing (for example, accessing data in a memory) and the like. Also, “determining” can include resolving, selecting, choosing, establishing, and the like.

In examples, determining the information 158 comprises transmitting/receiving one or more signals and/or messages comprising information to/from a target SN 156. This is illustrated in the example of FIG. 2 by the double headed arrow between block 208 and the target SN 156.

For example, the target MN 154 can transmit an SN Addition Request message to the target SN 156 and the target SN 156 can transmit an SN Addition Response message to the target MN 154.

The information 158 can comprise any suitable information. For example, the information 158 can comprise any suitable information to allow a determination of a condition 140 to access a target primary cell of a secondary cell group 142 of a target secondary node 156 associated with a conditional handover towards a target master node 154.

In examples, the information 158 comprises measurement related information. Measurement related information can comprise information about candidate target PSCell(s).

In some examples, measurement related information comprises measurement object information. For example, measurement object information can comprise at least one of:
PCIs and frequencies of prepared target PSCells,
SSB related configuration: SSB frequency, SSB subcarrier spacing, SSB indices to measure, Quasi-CoLocation relationship between SSB blocks,
CSI-RS related configuration: reference frequency for CSI-RS (see, for example, point A in 38.331),
Parameters to derive cell quality measurements: number of beam measurements to average, threshold for beam measurements used in deriving cell quality,
SMTC (measurement timing) configuration,
White cell list/black cell list.

In some examples, determining information 158, at block 208, comprises determining the condition 140 to access a target primary cell of a secondary cell group 142.

Accordingly, in examples, the determined information 158 comprises the condition 140 to access a target primary cell of a secondary cell group 142.

The condition 140 can be determined in any suitable way, using any suitable method.

In examples, determining the condition 140 comprises processing and/or evaluating information, for example measurement related information, to determine the condition 140

The condition 140 can comprise any suitable condition 140.

In some examples, the condition 140 can be a radio signal condition. For example, the condition 140 can comprise a received radio signal power condition and/or a received radio signal quality condition.

In examples, the condition 140 can be based on and/or related to reference signal received power (RSRP) and/or reference signal received quality (RSRQ).

In examples, the condition 140 can comprise, for example, A3, A4 or A5 event.

In some examples, the condition 140 can be a Conditional PSCell Addition and Change (CPAC) condition.

In examples a plurality of conditions 140 can be determined.

In examples, accessing a target primary cell of a secondary cell group, or any other suitable cell, comprises performing a random access procedure with the cell.

In examples, accessing a target primary cell of a secondary cell group, or any other suitable cell, comprises establishing a connection with the cell.

In some examples, determining information 158 comprises determining a measurement object and/or reporting configuration for the condition 140 to access a target primary cell of a secondary cell group 142.

In examples, the condition 140 can be included in the reporting configuration.

Accordingly, in examples, information 158 comprises a measurement object and reporting configuration for the condition 140 to access a target primary cell of a secondary cell group 142.

At block 210, method 200 comprises transmitting the determined information 158 to the source master node 152.

Accordingly, in examples block 210 comprises transmitting information 158 to allow a determination of a condition 140 to access a target primary cell of a secondary cell group 142 of a target secondary node 156 associated with a conditional handover towards a target master node 154 to be associated in a source primary cell measurement configuration 148 with a measurement identity 146 generated by a source master node 152.

Consequently, FIG. 2 illustrates a method 200 comprising: receiving a handover request 151; and transmitting information 158 to allow a determination of a condition 140 to access a target primary cell of a secondary cell group 142 of a target secondary node 156 associated with a conditional handover towards a target master node 154 to be associated in a source primary cell measurement configuration 148 with a measurement identity generated by a source master node 152.

As previously noted, in some examples, the determined information 158 comprises the condition 140.

Accordingly, in examples, method 200 comprises, for example at/by the target MN 154, determining the condition 140 to access a target primary cell of a secondary cell group 142 and wherein transmitting information 158 to allow a determination of a condition to access a target primary cell of a secondary cell group 142 comprises transmitting the determined condition.

As previously noted, in some examples, the determined information 158 comprises a reporting configuration of the condition 140 to access the target primary cell of the secondary cell group 142.

Accordingly, in examples, method 200 comprises, for example at/by the target MN 154, determining a reporting configuration of the condition 140 to access the target primary cell of the secondary cell group 142 and wherein transmitting information 158 to allow a determination of a condition 140 to access a target primary cell of a secondary cell group 142 comprises transmitting the determined reporting configuration.

The determined information 158 can be transmitted as part of a Handover Request Acknowledge message.

In examples, the target MN 154 determines a target primary cell measurement configuration 162. Accordingly, in some examples, method 200 comprises, for example at/by the target MN 154, determining a target primary cell measurement configuration 162.

The target primary cell measurement configuration 162 can include the condition 140 to access the target primary cell of a secondary cell group 142.

In examples, the target MN 154 can transmit the target primary cell measurement configuration 162 to the source MN 152. Accordingly, in examples, method 200 comprises transmitting the target primary cell measurement configuration 162 to the source MN 152 and correspondingly receiving the target primary cell measurement configuration 162 by the source MN 152.

In some examples, the target primary cell measurement configuration 162 is transmitted in addition to the determined information 158.

At block 212, method 200 comprises determining a condition 140 to access a target primary cell of a secondary cell group 142 of a target secondary node 156 associated with a conditional handover towards a target master node 154.

The condition 140 can be or comprise any suitable condition 140. In examples, the condition 140 is or comprises a condition 140 as described in relation to block 208.

Accordingly, in some examples, the condition 140 comprises a conditional PSCell addition and change, CPAC, condition.

Block 212 can be performed in any suitable way, using any suitable method.

Determining the condition 140 can comprise receiving and/or processing information.

In some examples, determining the condition 140 to access the target primary cell of the secondary cell group comprises receiving information 158 and determining the condition based, at least in part, on the received information 158.

The information 158 can be information 158 received from the target MN 154. Accordingly, in examples, the information 158 can be the information 158 determined at block 208 and can be as described in relation to block 208.

Accordingly, in some examples, the information 158 is received from a target MN 154 and comprises measurement related information.

Accordingly, in some examples, the measurement related information comprises measurement object information.

In examples, the source MN 152 generates a reporting configuration of the condition 140 to access the target primary cell of the secondary cell group 142.

Accordingly, in some examples, method 200 comprises generating, for example at and/or by the source MN 152, a reporting configuration of the condition 140 to access the target primary cell of the secondary cell group 142.

In examples, the condition 140 is included in the determined reporting configuration. As described above, in some examples, block 208 can comprise determining the condition 140 to access the target primary cell of the secondary cell group 142.

Accordingly, in some examples, determining, at block 210, the condition 140 to access the target primary cell of the secondary cell group 142 comprises receiving the condition 140.

In examples, the source MN 152 receives a reporting configuration of the condition 140 to access the target primary cell of the secondary cell group 142.

Accordingly, in some examples, method 200 comprises receiving, at and/or by the source MN 152, a reporting configuration of the condition 140 to access the target primary cell of the secondary cell group 142.

The reporting configuration of the condition 140 can be received with the information 158 at block 210.

In some examples, the reporting configuration of the condition 140 is received from the target MN separate from the information 158 at block 210.

At block 214, method 200 comprises generating a measurement identity 146 to be associated, in an updated source primary cell measurement configuration 148a, with the condition 140 to access the target primary cell of a secondary cell group 142 of a target secondary node 156 associated with a conditional handover towards a target master node 154.

Accordingly, in examples, if the target MN 154 provides the measurement object information, the source MN 152 can decide on the reporting configuration and generate a measurement ID 146 (see, for example, block 214).

Accordingly, in examples, if the target MN 154 provides the measurement object and reporting configuration, the source MN 152 can decide on the measurement ID 146 (see, for example, block 214) to associate the received measurement object with the received reporting configuration.

In examples, the source MN 152 includes the generated measurement ID 146, and the received measurement object and the received or generated reporting configuration in its own measurement configuration (see, for example, block 216).

Block 214 can be performed in any suitable way using any suitable method.

In examples, generating a measurement identity 146 at block 214 comprises creating and/or selecting and/or choosing and/or deciding on the measurement identity 146.

In some examples, generating a measurement identity 146 at block 214 comprises selecting a measurement identity 146 from a predetermined set of measurement identities.

As indicated by the location of block 214 in the example of FIG. 2, in examples block 214 is performed at and/or by the source MN 152.

Accordingly, in examples, the measurement identity 146 to be associated, in an updated source primary cell measurement configuration 148a, with the condition 140 to access the target primary cell of a secondary cell group 142 of a target secondary node 156 associated with a conditional handover towards a target master node 154 is generated by the source MN 152 and is not generated by the target MN 154.

That is, in examples, the measurement identity 146 to be associated, in an updated source primary cell measurement configuration 148a, with the condition 140 to access the target primary cell of a secondary cell group 142 of a target secondary node 156 associated with a conditional handover towards a target master node 154 is not generated and/or created prior to the source MN 152 receiving the information 158 at block 210.

That is, in examples, the measurement identity 146 to be associated, in an updated source primary cell measurement configuration 148a, with the condition 140 to access the target primary cell of a secondary cell group 142 of a target secondary node 156 associated with a conditional handover towards a target master node 154 is generated and/or created after the source MN 152 receives the information 158 at block 210

At block 216, method 200 comprises including, in an updated source primary cell measurement configuration 148a, the generated measurement identity 146 and the condition 140 to access the target primary cell of the secondary cell group 142.

Block 216 can be performed in any suitable way using any suitable method.

In examples, including, in an updated source primary cell measurement configuration 148a, the generated measurement identity 146 and the condition 140 to access the target primary cell of the secondary cell group 142 comprises inserting and/or inputting and/or including data and/or information in one or more data structures.

In some examples, block 216 comprises associating and/or connecting, and/or linking, and/or relating, in the updated source primary cell measurement configuration 148a, the generated measurement identity 146 and the condition 140 to access the target primary cell of the secondary cell group 142.

In some examples, block 216 comprises associating the generated measurement identity 146 with a measurement object and a reporting configuration of the condition 140 to access the primary cell of the secondary cell group 142.

In some examples, block 216 comprises including the generated measurement identity 146 in a data structure in association with an identifier of a measurement object and an identifier of a reporting configuration of the condition 140 to access the target primary cell of the secondary cell group 142.

Accordingly, in examples, the updated source primary cell measurement configuration 148a comprises the generated measurement identity 146 and the measurement object information received from the target MN 154.

Accordingly, in examples, the updated source primary cell measurement configuration 148a comprises the generated reporting configuration, that is, in examples, the reporting configuration generated by the source MN 152.

Accordingly, in examples, the updated source primary cell measurement configuration 148a comprises the reporting configuration received from the target MN 154.

In examples, the updated source primary cell measurement configuration 148a comprises a conditional handover (CHO) execution condition.

In some examples, there are a plurality of conditions 140 to access a plurality of target primary cells of the secondary cell group 142.

In some examples, the updated source primary cell measurement configuration 148a comprises a first CHO execution condition and a first condition 140a to access a target primary cell of a secondary cell group 142a associated with a first generated measurement identity ID1 and a second CHO execution condition and a second condition 140b to access a target primary cell of a secondary cell group 142b associated with a second generated measurement identity ID2, wherein the first and second conditions 140a, 140b to access a target primary cell of a secondary cell group 142a, 142b comprise conditional PSCell addition and change, CPAC, conditions.

In examples, the first and second CHO execution conditions can be the same.

At block 218, method 200 comprises, from the point of view of the UE 150, receiving, from the source master node 152, at least one measurement configuration 170 containing a condition 140 to access a target primary cell of a secondary cell group 142 of a target secondary node 156 associated with a conditional handover towards a target master node 154.

From the point of view of the source MN 152, block 218 comprises transmitting, to the UE 150, at least one measurement configuration 170 containing a condition 140 to access a target primary cell of a secondary cell group 142 of a target secondary node 156 associated with a conditional handover towards a target master node 154.

In examples, the condition 140 is the condition 140 determined at block 212.

The at least one measurement configuration 170 can be transmitted as part of an RRC Reconfiguration message.

The at least one measurement configuration 170 can comprise any suitable measurement configuration 170 or measurement configurations 170.

In some examples, the at least one measurement configuration 170 is a source primary cell measurement configuration 148.

In some examples, the at least one measurement configuration 170 is the updated source primary cell measurement configuration 148a of block 216.

Accordingly, in examples, block 218 comprises transmitting the updated source primary cell measurement configuration 148a to the user equipment 150.

Consequently, FIG. 2 illustrates a method 200 comprising: establishing a connection towards a user equipment, UE 150, via a source primary cell 174;
providing the UE 150 a source primary cell measurement configuration 148;
determining a condition to access a target primary cell of a secondary cell group 142 of a target secondary node 156 associated with a conditional handover towards a target master node 154;
generating a measurement identity 146 to be associated, in an updated source primary cell measurement configuration 148a, with the condition to access the target primary cell of the secondary cell group 142;
including, in an updated source primary cell measurement configuration 148a, the generated measurement identity 146 and the condition to access the target primary cell of the secondary cell group 142;
transmitting the updated source primary cell measurement configuration 148a to the user equipment 150.

In some examples, the at least one measurement configuration 170 comprises a target primary cell measurement configuration 162.

The target primary cell measurement configuration 162 can comprise a target primary cell measurement configuration 162 received by the source MN 152 from the target MN 154.

At block 220, method 200 comprises creating at least one measurement variable 172 for the received at least one measurement configuration 170.

Consequently, FIG. 2 illustrates a method 200 comprising:
establishing a connection towards a source master node 152;
receiving, from the source master node 152, at least one measurement configuration 170 containing a condition to access a target primary cell of a secondary cell group 142 of a target secondary node 156 associated with a conditional handover towards a target master node 154; and
creating at least one measurement variable 172 for the received at least one measurement configuration 170.

In examples, creating at least one measurement variable 172 can be performed in any suitable way using any suitable method.

In some examples, creating at least one measurement variable 172 comprises updating at least one measurement variable 172 and/or creating at least one measurement variable 172.

As described above, in examples, the at least one measurement configuration 170 is a source primary cell measurement configuration 148 and can be the updated source primary cell measurement configuration 148a of block 216.

In examples, creating at least one measurement variable 172 for the received at least one measurement configuration 170 comprises updating at least one measurement variable 172 associated with a source primary cell 174 to include a measurement identity 146 associated with the condition to access a target primary cell of a secondary cell group 142.

In some examples, the measurement identity 146 is the measurement identity 146 generated at block 214.

As described above, in examples, the at least one measurement configuration 170 comprises a target primary cell measurement configuration 162.

In some examples, the target primary cell measurement configuration 162 can comprise a target primary cell measurement configuration 162 received by the source MN 152 from the target MN 154.

In examples, creating the at least one measurement variable 172 comprises creating at least one independent measurement variable 172 for the target primary cell measurement configuration 162.

In some examples, the at least one measurement configuration 170 can comprise a plurality of target primary cell measurement configurations 162 and creating that least one measurement variable 172 can comprise creating at least one independent measurement variable 172 for each target primary cell measurement configuration 162.

As described above, in some examples, the source MN 152 receives the condition 140 to access the target primary cell of the secondary cell group 142 from the target MN 154 at block 212, performs blocks 214 and 216 and transmits an updated source primary cell measurement configuration 148a to the UE 150.

In some such examples, the target MN 154 determines a target primary cell measurement configuration 162 and associates the condition 140 to access the target primary cell of the secondary cell group 142 with a measurement identity, which can be considered a second measurement identity 166, in the target primary cell measurement configuration 162. The target MN 154 can provide the target primary cell measurement configuration 162 to the source MN 152.

In some such examples, the target MN 154 transmits, for example to the source MN 152, an indication 160 of a measurement identity, which can be considered a second measurement identity 166, associated, in a target primary cell measurement configuration 162, with the condition 140 to access the target primary cell of a secondary cell group 142.

Accordingly, in examples, method 200 comprises transmitting, for example at and/or by the target MN, an indication 160 of a measurement identity associated, in a target primary cell measurement configuration 162, with the condition 140 to access the target primary cell of a secondary cell group 142.

The indication can be transmitted in any suitable way using any suitable method.

In some examples, the indication 160 can be transmitted with the information 158 at block 210 or can be transmitted separate to the information 158 at block 210.

In examples, the indication 160 can be included in a Handover Request Acknowledge message.

The indication 160 can have any suitable form. For example, the indication can have any suitable form to indicate the measurement identity associated, in the target primary cell measurement configuration 162, with the condition 140 to access the target primary cell of a secondary cell group 142. The indication 160 can comprise any suitable flag or indicator and so on.

In some examples, the indication 160 of the measurement identity comprises the measurement identity associated, in a target primary cell measurement configuration 162, with the condition 140 to access the target primary cell of a secondary cell group 142.

Accordingly, from the point of view of the source MN 152, method 200 can comprise receiving, for example at and/or by the source MN 152, an indication 160, as described above, of a second measurement identity 166 associated, in a target primary cell measurement configuration 162, with the condition 140 to access the target primary cell of the secondary cell group 142.

In examples, the source MN 152 can transmit, to the UE 150, an indication to maintain 164, after application of the target primary cell measurement configuration 162, measurement information associated with evaluation of the condition 140 to access the target primary cell of a secondary cell group 142 that is associated with the generated measurement identity 146, for evaluation of the condition 140 to access the target primary cell of a secondary cell group 142 that is associated with the second measurement identity 162.

Consequently, method 200 can comprise:
receiving, for example at and/or by the source MN 152, an indication 160 of a second measurement identity 166 associated, in a target primary cell measurement configuration 162, with the condition 140 to access the target primary cell of the secondary cell group 142; and
transmitting, to the UE 150, an indication to maintain 164, after application of the target primary cell measurement configuration 162, measurement information associated with evaluation of the condition 140 to access the target primary cell of a secondary cell group 142 that is associated with the generated measurement identity 146, for evaluation of the condition 140 to access the target primary cell of a secondary cell group 142 that is associated with the second measurement identity 162.

The indication to maintain 164 can have any suitable form. For example, the indication to maintain 164 can have any suitable form to indicate, to the UE 150, to maintain, after application of the target primary cell measurement configuration 162, measurement information associated with evaluation of the condition 140 to access the target primary cell of a secondary cell group 142 that is associated with the generated measurement identity 146, for evaluation of the condition 140 to access the target primary cell of a secondary cell group 142 that is associated with the second measurement identity 162. The indication to maintain 164 can comprise any suitable flag or indicator and so on.

The indication to maintain 164 can be transmitted in any suitable way using any suitable method.

In some examples, the indication to maintain 164 can be transmitted at block 218 or can be transmitted separate to block 218.

In examples, the indication to maintain 164 can be included in an RRC reconfiguration message.

In some examples, the source MN 154 transmits, to the UE 150, the indication 160 of a measurement identity, which can be considered a second measurement identity 166, associated, in a target primary cell measurement configuration 162, with the condition 140 to access the target primary cell of a secondary cell group 142.

The indication 160 can be transmitted in any suitable way using any suitable method.

In some examples, the indication 160 can be transmitted at block 218 or can be transmitted separate to block 218.

In examples, the indication 160 can be included in a RRC Reconfiguration message.

In some examples, the indication to maintain 164 can comprise the indication 160 of a measurement identity, which can be considered a second measurement identity 166.

Accordingly, from the point of view of the UE 150, method 200 can comprise receiving an indication to maintain 164, after application of a target primary cell measurement configuration 162, measurement information associated with the condition 140 to access the target primary cell of a secondary cell group 142 that is associated with the measurement identity 146, for evaluation of the condition 140 to access the target primary cell of a secondary cell group 142 that is associated with a second measurement identity 162 in the target primary cell measurement configuration 162.

The indication to maintain 164 can be as described above. For example, the indication 164 can comprise the second measurement identity 166.

As described above, in some examples, the at least one measurement configuration 170, received by the UE 150 at block 218, comprises a target primary cell measurement configuration 162 and the UE 150 creates at least one independent measurement variable 172 for the target primary cell measurement configuration 162.

In some such examples, the target MN 154 can provide an indication to maintain 164, after application of the target primary cell measurement configuration 162, measurement information for evaluation of the condition to access a target primary cell of a secondary cell group 142. See, for example, FIG. 3.

The indication to maintain 164 can be provided to the source MN 152, for example in a conditional handover configuration.

In some examples the indication to maintain 164 is provided to the source MN 152 as part of a Handover Request Acknowledge message.

In some such examples, the indication to maintain 164 can have any suitable form. For example, the indication to maintain 164 can have any suitable form to indicate to a UE 150 to maintain, after application of the target primary cell measurement configuration 162, measurement information for evaluation of the condition to access a target primary cell of a secondary cell group 142.

In some examples, the indication to maintain 164 comprises a flag.

In examples, the source MN 152 transmits the indication to maintain 164 to the UE 150.

In some examples, the indication 164 can be transmitted at block 218 or can be transmitted separate to block 218.

Accordingly, from the point of view of the UE 150, in some such examples method 200 can comprise receiving an indication to maintain 164, after application of the target primary cell measurement configuration 162, measurement information for evaluation of the condition 140 to access a target primary cell of a secondary cell group 142.

For example, the UE 150, can receive an indication to maintain 164, after application of the target primary cell measurement configuration 162, measurement information for evaluation of the condition 140 to access a target primary cell of a secondary cell group 142 obtained in relation to the independent at least one measurement variable 172 that was created for the target primary cell measurement configuration 162.

Accordingly, in various examples, the source MN 152 can instruct and/or configure the UE 150 to maintain, after application of a target primary cell measurement configuration 162, measurement information associated with and/or associated with evaluation of the condition 140 to access the target primary cell of a secondary cell group 142.

At block 222, method 200 comprises applying the target primary cell measurement configuration 162.

For example, the UE 150 can determine that a conditional handover condition is met and applies the target primary cell measurement configuration 162.

In examples, the target primary cell measurement configuration 162 is included with the conditional reconfiguration of the target cell. By applying the target PCell measurement configuration 162, the UE 150 is configured to perform/performs measurements according to the measurement objects that are provided in the measurement configuration.

In some examples, the UE 150 can perform the handover to the target MN and can, for example, establish a connection towards the target MN 154. This is illustrated in the example of FIG. 2 by the double headed arrow at block 222.

At block 224, method 200 comprises maintaining, after application of a target primary cell measurement configuration 162, measurement information associated with and/or associated with evaluation of the condition 140 to access the target primary cell of a secondary cell group 142.

Maintaining measurement information can be performed in any suitable way using any suitable method.

For example, maintaining measurement information can comprise maintaining measurement information in at least one data structure.

For example, maintaining measurement information can comprise not resetting and/or not deleting and/or not removing measurement information.

Measurement information associated with and/or associated with evaluation of the condition 140 to access the target primary cell of a secondary cell group 142 can comprise any suitable information. For example, the measurement information can comprise any suitable information for use by the UE to assess whether the condition 140 to access the target primary cell of a secondary cell group 142 has been satisfied.

In examples, the UE 150 uses the maintained measurement information for evaluation of the condition 140 to access the target primary cell of a secondary cell group 142 after application of the target primary cell measurement configuration 162.

Accordingly, in examples, method 200 comprises using, at and/or by the UE 150, the maintained measurement information for evaluation of the condition 140 to access the target primary cell of a secondary cell group 142 after application of the target primary cell measurement configuration 162.

In some examples, method 200 comprises, using, at and/or by the UE 150, the maintained measurement information for evaluation of the condition 140 to access the target primary cell of a secondary cell group 142 that is associated with the second measurement identity 166 in the target primary cell measurement configuration 162.

In examples, method 200 can include a plurality of target SNs. Accordingly, in some examples, a plurality of conditions to access the plurality of target primary cell of a secondary cell group can be determined and used in method 200.

For example, at least one condition can be determined for each of the plurality of target primary cell of a secondary cell group.

In examples, the condition 140 to access a target primary cell of a secondary cell group 142 can be one of a plurality of such conditions.

The illustration of a particular order to the blocks in FIG. 2 does not necessarily imply that there is a required or preferred order for the blocks and the order and arrangement of the block may be varied. Furthermore, it may be possible for some blocks to be omitted.

For example, in some examples, blocks 212 to 216 can be omitted when the Source MN transmits at least one target primary cell measurement configuration 162 to the UE 150.

Examples of the disclosure are advantageous and provide technical benefits.

For example, examples of the disclosure provide for a UE to re-use a source primary cell measurement configuration for evaluation of the condition associated with accessing target PSCells that are prepared by a target MN.

For example, examples of the disclosure allow the UE to evaluate the condition associated with accessing prepared target PSCells by creating independent UE measurement variables for each prepared target PCell measurement configuration.

In such examples, a target PCell can still decide on the condition associated with accessing the prepared target PSCells.

FIG. 3 illustrates an example of a method 300.

FIG. 3 is similar to the example of FIG. 2 and similarly shows the plurality of apparatus transmitting and/or receiving one or more signals and/or one or more messages across and/or via and/or using a network.

In examples, the plurality of apparatuses in FIG. 3 form at least a portion of a network 100 as described in relation to FIG. 1.

In examples, FIG. 3 can be considered to illustrate a plurality of methods. For example, FIG. 3 illustrates one or more actions at a plurality of actors/entities. In examples, FIG. 3 can be considered to illustrate a plurality of methods performed by the individual actors/entities.

In the illustrated example, a terminal node 110, and three access nodes 120 transmit and/or receive one or more signals and/or one or more messages. In the example of FIG. 2 the terminal node 110 is a UE 150 and the three access nodes 120 are a source MN 152, a target MN 154, and a target SN 156.

In examples (not illustrated in FIG. 3) the UE 150 can also be connected to a source SN.

In examples, communications and/or transmissions between elements illustrated in FIG. 3 can proceed via any number of intervening elements, including no intervening elements.

Although one UE 150 is illustrated in the example of FIG. 3, in examples any suitable number of UEs 150 can be included.

Similarly, in examples, any suitable number of network nodes can be included.

In examples, method 300 and/or parts of method 300 can be considered a method of enhancing conditional handover.

In examples, method 300 and/or one or more parts of method 300 can be considered a method of enhancing conditional handover with dual connectivity.

In examples, method 300 and/or one or more parts of method 300 can be considered a method of handling measurement variables.

In examples, method 300 and/or one or more parts of method 300 can be considered a method of handling UE measurement information.

In the illustrated example, the location of the blocks indicates the entity performing the action(s). For example, block 308 is performed at/by the target MN 154.

At block 302, method 300 comprises establishing a connection between a UE 150 and a source MN 152. This is illustrated in the example of FIG. 3 by the double headed arrow between the UE 150 and source MN 152.

Block 302 can be as described in relation to block 202 of the example of FIG. 2.

At block 304, method 300 comprises providing the UE 150 a source primary cell measurement configuration 148.

Block 304 can be as described in relation to block 204 of the example of FIG. 2.

At block 306, method 300 comprises, from the point of view of the target MN 154, receiving a handover request 151. Accordingly, from the point of view of the source MN 152, block 206 illustrates transmitting a handover request 151.

Block 306 can be as described in relation to block 206 of the example of FIG. 2.

At block 308, method 300 comprises determining a condition 140 to access a target primary cell of a secondary cell group 142 of a target secondary node 156 associated with a conditional handover towards a target master node 154.

Block 308 can be as described in relation to determining the condition 140 at block 208 of the example of FIG. 2.

At block 310, method 300 comprises generating a measurement identity to be associated, in a target primary cell measurement configuration 162, with the condition 140 to access a target primary cell of a secondary cell group 142.

Block 310 can be performed in any suitable way using any suitable method.

In examples, generating a measurement identity at block 310 comprises creating and/or selecting and/or choosing and/or deciding on the measurement identity.

In some examples, generating a measurement identity at block 310 comprises selecting a measurement identity from a predetermined set of measurement identities.

At block 312, method 300 comprises including the generated measurement identity and determined condition 140 in a target primary cell measurement configuration 162.

Block 312 can be performed in any suitable way using any suitable method.

In examples, including the generated measurement identity and determined condition 140 in a target primary cell measurement configuration 162, comprises inserting and/or inputting and/or including data and/or information in one or more data structures.

In some examples, block 312 comprises associating and/or connecting, and/or linking, and/or relating, in the target primary cell measurement configuration 162, the generated measurement identity and the condition 140 to access the target primary cell of the secondary cell group 142.

In some examples, block 312 comprises associating the generated measurement identity with a measurement object and a reporting configuration of the condition 140 to access the primary cell of the secondary cell group 142.

In some examples, block 312 comprises including the generated measurement identity in a data structure in association with an identifier of a measurement object and an identifier of a reporting configuration of the condition 140 to access the target primary cell of the secondary cell group 142.

At block 314, method 300 comprises, from the point of view of the target MN 154, transmitting the target primary cell measurement configuration 162 to a source master node 152.

The target primary cell measurement configuration 162 can be transmitted as part of a Handover Request Acknowledge message.

Accordingly, from the point of view of the source MN 152, block 314 comprises receiving, from a target master node 154, a target primary cell measurement configuration 162 including a measurement identity and condition 140 to access a target primary cell of a secondary group 142 of a target secondary node 156 associated with a conditional handover towards the target master node 154.

At block 316, method 300 comprises, from the point of view of the target MN 154, transmitting an indication to maintain 164, after application of the target primary cell measurement configuration 162, measurement information for evaluation of the condition 140 to access a target primary cell of a secondary cell group 142.

Consequently, FIG. 3 illustrates a method 300 comprising:
receiving a handover request 151;
determining a condition 140 to access a target primary cell of a secondary cell group 142 of a target secondary node 156 associated with a conditional handover towards a target master node 154;
generating a measurement identity to be associated, in a target primary cell measurement configuration 162, with the condition 140 to access a target primary cell of a secondary cell group 142;
including the generated measurement identity and determined condition 140 in a target primary cell measurement configuration 162;
transmitting the target primary cell measurement configuration 162 to a source master node 152; and
transmitting an indication to maintain, after application of the target primary cell measurement configuration 162, measurement information for evaluation of the condition to access a target primary cell of a secondary cell group 142.

Although, in the example of FIG. 3, the indication to maintain 164 is illustrated as transmitted separately to the target primary cell measurement configuration 162, in some examples the indication to maintain 164 can be transmitted with the target primary cell measurement configuration 162.

For example, the indication to maintain 164 can be transmitted as part of a Handover Request Acknowledge message.

The indication to maintain 164 can have any suitable form. For example, the indication to maintain 164 can have any suitable form to indicate to a UE 150 to maintain, after application of the target primary cell measurement configuration 162, measurement information for evaluation of the condition to access a target primary cell of a secondary cell group 142.

In some examples, the indication to maintain 164 comprises a flag.

In some examples, the indication 164 comprises an indication to maintain, after conditional handover (CHO) execution, measurement information for evaluation of the condition to access a target primary cell of a secondary cell group 142.

From the point of view of the source MN 152, block 316 comprises receiving an indication to maintain, after application of the target primary cell measurement configuration 162, measurement information for evaluation of the condition 140 to access a target primary cell of a secondary cell group 142.

At block 318, method 300 comprises assigning the conditional handover conditions for each target primary cell.

At block 320, method 300 comprises, from the point of view of the source MN 152, transmitting the target primary cell measurement configuration 162 and indication 164 to a user equipment 150.

Consequently, FIG. 3 illustrates a method 300 comprising:
receiving, from a target master node 154, a target primary cell measurement configuration 162 including a condition 140 to access a target primary cell of a secondary cell group 142 of a target secondary node 156 associated with a conditional handover towards the target master node 154;
receiving an indication to maintain 164, after application of the target primary cell measurement configuration 162, measurement information for evaluation of the condition 140 to access a target primary cell of a secondary cell group; and
transmitting the target primary cell measurement configuration 162 and indication 164 to a user equipment 150.

In examples, the target primary cell measurement configuration 162 and indication 164 can be transmitted as part of an RRC Reconfiguration message.

In examples, the source MN 152 also transmits a source primary cell measurement configuration 148 to the UE 150.

In examples, the UE 150 can perform one or more of blocks 220, 222, and 224 as described in relation to FIG. 2.

FIG. 4 illustrates an example of a method 400.

In examples, method 400 can be performed by any suitable apparatus comprising any suitable means for performing method 400. For example, an apparatus as described in relation to FIGS. 12A and/or 12B.

In examples, method 400 can be performed by a source MN 152, such as a source MN 152 of FIG. 2.

At block 402, method 400 comprises establishing a connection towards a user equipment, UE 150, via a source primary cell 174.

At block 404, method 400 comprises providing the UE 150 a source primary cell measurement configuration 148.

At block 406, method 400 comprises determining a condition 140 to access a target primary cell of a secondary cell group 142 of a target secondary node 156 associated with a conditional handover towards a target master node 154.

At block 408, method 400 comprises generating a measurement identity 146 to be associated, in an updated source primary cell measurement configuration 148a, with the condition 140 to access the target primary cell of a secondary cell group 142 of a target secondary node 156 associated with a conditional handover towards a target master node 154.

At block 410, method 400 comprises including, in an updated source primary cell measurement configuration 148a, the generated measurement identity 146 and the condition 140 to access the target primary cell of the secondary cell group 142.

At block 412, method 400 comprises transmitting the updated source primary cell measurement configuration 148 to the user equipment 150.

Consequently, FIG. 4 illustrates a method 400 comprising:
establishing a connection towards a user equipment, UE, via a source primary cell; providing the UE a source primary cell measurement configuration;
determining a condition to access a target primary cell of a secondary cell group of a target secondary node associated with a conditional handover towards a target master node;
generating a measurement identity to be associated, in an updated source primary cell measurement configuration, with the condition to access the target primary cell of a secondary cell group of a target secondary node associated with a conditional handover towards a target master node;
including, in an updated source primary cell measurement configuration, the generated measurement identity and the condition to access the target primary cell of the secondary cell group;
transmitting the updated source primary cell measurement configuration to the user equipment.

FIG. 5 illustrates an example of a method 500.

In examples, method 500 can be performed by any suitable apparatus comprising any suitable means for performing method 500. For example, an apparatus as described in relation to FIGS. 12A and/or 12B.

In examples, method 500 can be performed by a target MN 154, such as a target MN 154 of FIG. 2.

At block 502, method 500 comprises receiving a handover request 151.

At block 504, method 500 comprises transmitting information 158 to allow a determination of a condition 140 to access a target primary cell of a secondary cell group 142 of a target secondary node 156 associated with a conditional handover towards a target master node 154 to be associated in a source primary cell measurement configuration 148 with a measurement identity 146 generated by a source master node 152.

Consequently, FIG. 5 illustrates a method 500 comprising:
receiving a handover request; and
transmitting information to allow a determination of a condition to access a target primary cell of a secondary cell group of a target secondary node associated with a conditional handover towards a target master node to be associated in a source primary cell measurement configuration with a measurement identity generated by a source master node.

FIG. 6 illustrates an example of a method 600.

In examples, method 600 can be performed by any suitable apparatus comprising any suitable means for performing method 500. For example, an apparatus as described in relation to FIGS. 12A and/or 12B.

In examples, method 600 can be performed by a UE 150, such as a UE 150 of FIG. 1 and/or FIG. 2.

At block 602, method 600 comprises establishing a connection towards a source master node 152.

At block 604, method 600 comprises receiving, from the source master node 152, at least one measurement configuration 170 containing a condition 140 to access a target primary cell of a secondary cell group 142 of a target secondary node 156 associated with a conditional handover towards a target master node 154.

At block 606, method 600 comprises creating at least one measurement variable 172 for the received at least one measurement configuration 170.

Consequently, FIG. 6 illustrates a method 600 comprising:
establishing a connection towards a source master node;
receiving, from the source master node, at least one measurement configuration containing a condition to access a target primary cell of a secondary cell group of a target secondary node associated with a conditional handover towards a target master node; and
creating at least one measurement variable for the received at least one measurement configuration.

FIG. 7 illustrates an example of a method 700.

In examples, method 700 can be performed by any suitable apparatus comprising any suitable means for performing method 500. For example, an apparatus as described in relation to FIGS. 12A and/or 12B.

In examples, method 700 can be performed by a target MN 154, such as a target MN 154 of FIG. 2.

At block 702, method 700 comprises receiving a handover request 151.

At block 704, method 700 comprises determining a condition 140 to access a target primary cell of a secondary cell group 142 of a target secondary node 156 associated with a conditional handover towards a target master node 154.

At block 706, method 700 comprises generating a measurement identity to be associated, in a target primary cell measurement configuration 162, with the condition 140 to access a target primary cell of a secondary cell group 142.

At block 708, method 700 comprises including the generated measurement identity and determined condition 140 in a target primary cell measurement configuration 162.

At block 710, method 700 comprises transmitting the target primary cell measurement configuration 162 to a source master node 152.

At block 712, method 700 comprises transmitting an indication to maintain 164, after application of the target primary cell measurement configuration 162, measurement information for evaluation of the condition 140 to access a target primary cell of a secondary cell group 142.

Consequently, FIG. 7 illustrates a method 700 comprising:
receiving a handover request; and
determining a condition to access a target primary cell of a secondary cell group of a target secondary node associated with a conditional handover towards a target master node;
generating a measurement identity to be associated, in a target primary cell measurement configuration, with the condition to access a target primary cell of a secondary cell group;
including the generated measurement identity and determined condition in a target primary cell measurement configuration;
transmitting the target primary cell measurement configuration to a source master node; and
transmitting an indication to maintain, after application of the target primary cell measurement configuration, measurement information for evaluation of the condition to access a target primary cell of a secondary cell group.

FIG. 8 illustrates an example of a method 800.

In examples, method 800 can be performed by any suitable apparatus comprising any suitable means for performing method 400. For example, an apparatus as described in relation to FIGS. 12A and/or 12B.

In examples, method 800 can be performed by a source MN 152, such as a source MN 152 of FIG. 2.

At block 802, method 800 comprises receiving, from a target master node 154, a target primary cell measurement configuration 162 including a measurement identity and condition 140 to access a target primary cell of a secondary cell group 142 of a target secondary node 156 associated with a conditional handover towards the target master node 154.

At block 804, method 800 comprises receiving an indication to maintain 164, after application of the target primary cell measurement configuration 162, measurement information for evaluation of the condition 140 to access a target primary cell of a secondary cell group 142.

At block 806, method 800 comprises transmitting the target primary cell measurement configuration 162 and indication 164 to a user equipment 150.

Consequently, FIG. 8 illustrates a method 800 comprising:
receiving, from a target master node, a target primary cell measurement configuration including a measurement identity and condition to access a target primary cell of a secondary cell group of a target secondary node associated with a conditional handover towards the target master node;
receiving an indication to maintain, after application of the target primary cell measurement configuration, measurement information for evaluation of the condition to access a target primary cell of a secondary cell group; and
transmitting the target primary cell measurement configuration and indication to a user equipment.

FIG. 9 illustrates an example of a method 900.

Some examples relate to third generation Partnership Project (3GPP) network. FIG. 9 can be considered to illustrate some such examples.

The following description can be considered to illustrate some such examples.

In FIG. 9, the UE 150 performs evaluations of Conditional PSCell Addition and Change (CPAC) condition after block 13.

If the CHO condition is met first, the UE 150 would apply one of the two CHO config 1-1 and 1-2. At this point, the UE 150 will apply the measurement configuration of the target PCell which is part of CHO config.

However, in examples, applying a new measurement configuration may lead to restarting the measurement evaluations (clearing all L1 beam measurement, L3 cell quality measurements, resetting L3 filter for cell quality measurements, etc.) from scratch.

FIG. 10 shows a method 1000 where the UE 150 can use the measurements performed during CHO evaluation to continue the evaluations of the Conditional PSCell Addition and Change (CPAC) conditions that are associated with target PSCell (started after step 13) after the CHO execution.

Note that the measurement object and reporting configuration of measurement ID 1 (generated by target MN) are the same as those used for measurement ID 2 (generated by source MN). As such, the measurements for CPAC conditons started at step 13 can be re-used after CHO execution in step 15 for the evaluation of CPAC measurement ID 2.

FIG. 11 illustrates an example of a method 1100.

Some examples relate to third generation Partnership Project (3GPP) network. FIG. 11 can be considered to illustrate some such examples relating to third generation Partnership Project (3GPP) network.

In the example of FIG. 11, blocks 7 and 14 allow the UE 150 to continue the measurement of CPAC condition after the CHO condition is met, that is, upon execution of target MCG (measurement) configuration.

Examples of the disclosure are advantageous.

For example, a technical benefit provided by examples of the disclosure is re-using a source PCell measurement configuration for the evaluation of the condition associated with target PSCells of prepared target PCell for conditional handover. This can, for example, avoid defining independent UE measurement variables for each non-serving target PCell measurement configuration.

For example, a technical benefit provided by examples of the disclosure is allowing a UE to evaluate the condition of the prepared target PSCells by creating independent UE measurement variables for each prepared target PCell measurement configuration. This can allow the target PCell to still decide on the condition of the prepared target PSCell(s).

FIG. 12A illustrates an example of an apparatus 130. The apparatus 130 may be a controller of an apparatus or device such as a terminal node 110, for example UE 150, or network element 152, 154 and/or 156, such as an eNB or gNB. The apparatus 130 may be considered a controller.

Implementation of a controller 130 may be as controller circuitry. The controller 130 may be implemented in hardware alone, have certain aspects in software including firmware alone or can be a combination of hardware and software (including firmware).

As illustrated in FIG. 12A the controller 130 may be implemented using instructions that enable hardware functionality, for example, by using executable instructions of a computer program 136 in a general-purpose or special-purpose processor 132 that may be stored on a computer readable storage medium (disk, memory etc.) to be executed by such a processor 132.

The processor 132 is configured to read from and write to the memory 134. The processor 132 may also comprise an output interface via which data and/or commands are output by the processor 132 and an input interface via which data and/or commands are input to the processor 132.

The memory 134 stores a computer program 136 comprising computer program instructions (computer program code) that controls the operation of the apparatus 130 when loaded into the processor 132. The computer program instructions, of the computer program 136, provide the logic and routines that enables the apparatus to perform the methods illustrated in the accompanying Figs. The processor 132 by reading the memory 134 is able to load and execute the computer program 136.

In examples, the apparatus 130 comprises:
at least one processor; and
at least one memory including computer program code,
the at least one memory storing instructions that, when executed by the at least one processor, cause the apparatus at least to:
   establish a connection towards a user equipment, UE, via a source primary cell;
   provide the UE a source primary cell measurement configuration;
   determine a condition to access a target primary cell of a secondary cell group of a target secondary node associated with a conditional handover towards a target master node;
   generate a measurement identity to be associated, in an updated source primary cell measurement configuration, with the condition to access the target primary cell of a secondary cell group of a target secondary node associated with a conditional handover towards a target master node;
   including, in an updated source primary cell measurement configuration, the generated measurement identity and the condition to access the target primary cell of the secondary cell group;
   transmit the updated source primary cell measurement configuration to the user equipment.

In examples, the apparatus 130 comprises:
at least one processor; and
at least one memory including computer program code,
the at least one memory storing instructions that, when executed by the at least one processor, cause the apparatus at least to:
   receive a handover request; and
   transmit information to allow a determination of a condition to access a target primary cell of a secondary cell group of a target secondary node associated with a conditional handover towards a target master node to be associated in a source primary cell measurement configuration with a measurement identity generated by a source master node.

In examples, the apparatus 130 comprises:
at least one processor; and
at least one memory including computer program code,
the at least one memory storing instructions that, when executed by the at least one processor, cause the apparatus at least to:
   establish a connection towards a source master node;
   receive, from the source master node, at least one measurement configuration containing a condition to access a target primary cell of a secondary cell group of a target secondary node associated with a conditional handover towards a target master node; and
   create at least one measurement variable for the received at least one measurement configuration.

In examples, the apparatus 130 comprises:
at least one processor; and
at least one memory including computer program code,
the at least one memory storing instructions that, when executed by the at least one processor, cause the apparatus at least to:
   receive a handover request; and
   determine a condition to access a target primary cell of a secondary cell group of a target secondary node associated with a conditional handover towards a target master node;
generate a measurement identity to be associated, in a target primary cell measurement configuration, with the condition to access a target primary cell of a secondary cell group;
including the generated measurement identity and determined condition in a target primary cell measurement configuration;
transmitting the target primary cell measurement configuration to a source master node; and
transmitting an indication to maintain, after application of the target primary cell measurement configuration, measurement information for evaluation of the condition to access a target primary cell of a secondary cell group.

In examples, the apparatus 130 comprises:
at least one processor; and
at least one memory including computer program code,
the at least one memory storing instructions that, when executed by the at least one processor, cause the apparatus at least to:
   receiving, from a target master node, a target primary cell measurement configuration including a measurement identity and condition to access a target primary cell of a secondary cell group of a target secondary node associated with a conditional handover towards the target master node;
   receiving an indication to maintain, after application of the target primary cell measurement configuration, measurement information for evaluation of the condition to access a target primary cell of a secondary cell group; and
   transmitting the target primary cell measurement configuration and indication to a user equipment.

As illustrated in FIG. 12A, the computer program 136 may arrive at the apparatus 130 via any suitable delivery mechanism 162. The delivery mechanism 162 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 136. The delivery mechanism may be a signal configured to reliably transfer the computer program 136. The apparatus 130 may propagate or transmit the computer program 136 as a computer data signal.

Computer program instructions for causing an apparatus to perform at least the following or for performing at least the following:
establishing a connection towards a user equipment, UE, via a source primary cell;
providing the UE a source primary cell measurement configuration;
determining a condition to access a target primary cell of a secondary cell group of a target secondary node associated with a conditional handover towards a target master node;
generating a measurement identity to be associated, in an updated source primary cell measurement configuration, with the condition to access the target primary cell of a secondary cell group of a target secondary node associated with a conditional handover towards a target master node;
including, in an updated source primary cell measurement configuration, the generated measurement identity and the condition to access the target primary cell of the secondary cell group;
transmitting the updated source primary cell measurement configuration to the user equipment.

Computer program instructions for causing an apparatus to perform at least the following or for performing at least the following:
receiving a handover request; and
transmitting information to allow a determination of a condition to access a target primary cell of a secondary cell group of a target secondary node associated with a conditional handover towards a target master node to be associated in a source primary cell measurement configuration with a measurement identity generated by a source master node.

Computer program instructions for causing an apparatus to perform at least the following or for performing at least the following:
establishing a connection towards a source master node;
receiving, from the source master node, at least one measurement configuration containing a condition to access a target primary cell of a secondary cell group of a target secondary node associated with a conditional handover towards a target master node; and
creating at least one measurement variable for the received at least one measurement configuration.

Computer program instructions for causing an apparatus to perform at least the following or for performing at least the following:
receiving a handover request; and
determining a condition to access a target primary cell of a secondary cell group of a target secondary node associated with a conditional handover towards a target master node;
generating a measurement identity to be associated, in a target primary cell measurement configuration, with the condition to access a target primary cell of a secondary cell group;
including the generated measurement identity and determined condition in a target primary cell measurement configuration;
transmitting the target primary cell measurement configuration to a source master node; and
transmitting an indication to maintain, after application of the target primary cell measurement configuration, measurement information for evaluation of the condition to access a target primary cell of a secondary cell group.

Computer program instructions for causing an apparatus to perform at least the following or for performing at least the following:
receiving, from a target master node, a target primary cell measurement configuration including a measurement identity and condition to access a target primary cell of a secondary cell group of a target secondary node associated with a conditional handover towards the target master node;
receiving an indication to maintain, after application of the target primary cell measurement configuration, measurement information for evaluation of the condition to access a target primary cell of a secondary cell group; and transmitting the target primary cell measurement configuration and indication to a user equipment.

The computer program instructions may be comprised in a computer program, a non-transitory computer readable medium, a computer program product, a machine readable medium. In some but not necessarily all examples, the computer program instructions may be distributed over more than one computer program.

Although the memory 134 is illustrated as a single component/circuitry it may be implemented as one or more separate components/circuitry some or all of which may be integrated/removable and/or may provide permanent/semi-permanent/ dynamic/cached storage.

In examples the memory 134 comprises a random access memory 158 and a read only memory 160. In examples the computer program 136 can be stored in the read only memory 158. See, for example, FIG. 12B

In some examples the memory 134 can be split into random access memory 158 and read only memory 160.

Although the processor 132 is illustrated as a single component/circuitry it may be implemented as one or more separate components/circuitry some or all of which may be integrated/removable. The processor 132 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation. This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying Figs may represent steps in a method and/or sections of code in the computer program 136. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

Thus, the apparatus 130 can, in examples, comprise means for:
establishing a connection towards a user equipment, UE, via a source primary cell;
providing the UE a source primary cell measurement configuration;
determining a condition to access a target primary cell of a secondary cell group of a target secondary node associated with a conditional handover towards a target master node;
generating a measurement identity to be associated, in an updated source primary cell measurement configuration, with the condition to access the target primary cell of a secondary cell group of a target secondary node associated with a conditional handover towards a target master node;
including, in an updated source primary cell measurement configuration, the generated measurement identity and the condition to access the target primary cell of the secondary cell group;
transmitting the updated source primary cell measurement configuration to the user equipment.

Thus, the apparatus 130 can, in examples, comprise means for:
receiving a handover request; and
transmitting information to allow a determination of a condition to access a target primary cell of a secondary cell group of a target secondary node associated with a conditional handover towards a target master node to be associated in a source primary cell measurement configuration with a measurement identity generated by a source master node.

Thus, the apparatus 130 can, in examples, comprise means for:
establishing a connection towards a source master node;
receiving, from the source master node, at least one measurement configuration containing a condition to access a target primary cell of a secondary cell group of a target secondary node associated with a conditional handover towards a target master node; and
creating at least one measurement variable for the received at least one measurement configuration.

Thus, the apparatus 130 can, in examples, comprise means for:
receiving a handover request; and
determining a condition to access a target primary cell of a secondary cell group of a target secondary node associated with a conditional handover towards a target master node;
generating a measurement identity to be associated, in a target primary cell measurement configuration, with the condition to access a target primary cell of a secondary cell group;
including the generated measurement identity and determined condition in a target primary cell measurement configuration;
transmitting the target primary cell measurement configuration to a source master node; and
transmitting an indication to maintain, after application of the target primary cell measurement configuration, measurement information for evaluation of the condition to access a target primary cell of a secondary cell group.

Thus, the apparatus 130 can, in examples, comprise means for:
receiving, from a target master node, a target primary cell measurement configuration including a measurement identity and condition to access a target primary cell of a secondary cell group of a target secondary node associated with a conditional handover towards the target master node;
receiving an indication to maintain, after application of the target primary cell measurement configuration, measurement information for evaluation of the condition to access a target primary cell of a secondary cell group; and
transmitting the target primary cell measurement configuration and indication to a user equipment.

In examples, an apparatus 130 can comprise means for performing one or more methods, or at least part of one or more methods, as disclosed herein.

In examples, an apparatus 130 can be configured to perform one or more methods, or at least a part of one or more methods, as disclosed herein.

The above-described examples find application as enabling components of:
automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1-69. (canceled)

70. An apparatus comprising;
at least one processor; and
at least one memory including computer program code,
the at least one memory storing instructions that, when executed by the at least one processor, cause the apparatus at least to:
establish a connection towards a user equipment, UE, via a source primary cell;
provide the UE a source primary cell measurement configuration;
determine a condition to access a target primary cell of a secondary cell group of a target secondary node associated with a conditional handover towards a target master node;
generate a measurement identity to be associated, in an updated source primary cell measurement configuration, with the condition to access the target primary cell of a secondary cell group of a target secondary node associated with a conditional handover towards a target master node;
including, in an updated source primary cell measurement configuration, the generated measurement identity and the condition to access the target primary cell of the secondary cell group;
transmit the updated source primary cell measurement configuration to the user equipment.

71. An apparatus as claimed in claim 70, wherein determining the condition to access the target primary cell of the secondary cell group comprises receiving information and determining the condition based, at least in part, on the received information.

72. An apparatus as claimed in claim 71, wherein the information is received from a target master node and comprises measurement related information.

73. An apparatus as claimed in claim 72, wherein the measurement related information comprises measurement object information.

74. An apparatus as claimed in claim 71, the at least one memory storing instructions that, when executed by the at least one processor, cause the apparatus at least to generate a reporting configuration of the condition to access the target primary cell of the secondary cell group.

75. An apparatus as claimed in claim 71, wherein the condition comprises a conditional PSCell addition and change, CPAC, condition.

76. An apparatus as claimed in claim 73, wherein the updated source primary cell measurement configuration comprises the generated measurement identity and the measurement object information received from the target master node.

77. An apparatus as claimed in claim 74, wherein the updated source primary cell measurement configuration comprises the generated reporting configuration.

78. An apparatus as claimed in claim 70, wherein determining the condition to access the target primary cell of the secondary cell group comprises receiving the condition.

79. An apparatus as claimed in claim 78, the at least one memory storing instructions that, when executed by the at least one processor, cause the apparatus at least to receive a reporting configuration of the condition to access the target primary cell of the secondary cell group.

80. An apparatus as claimed in claim 70, wherein the updated source primary cell measurement configuration comprises a conditional handover, CHO, execution condition.

81. An apparatus as claimed in claim 80, wherein the updated source primary cell measurement configuration comprises a first CHO execution condition and a first condition to access a target primary cell of a secondary cell group associated with a first generated measurement identity and a second CHO execution condition and a second condition to access a target primary cell of a secondary cell group associated with a second generated measurement identity, wherein the first and second conditions to access a target primary cell of a secondary cell group comprise conditional PSCell addition and change, CPAC, conditions.

82. An apparatus as claimed in claim 70, the at least one memory storing instructions that, when executed by the at least one processor, cause the apparatus at least to:
receive an indication of a second measurement identity associated, in a target primary cell measurement configuration, with the condition to access the target primary cell of the secondary cell group; and
transmit, to the UE, an indication to maintain, after application of the target primary cell measurement configuration, measurement information associated with evaluation of the condition to access the target primary cell of a secondary cell group that is associated with the generated measurement identity, for evaluation of the condition to access the target primary cell of a secondary cell group that is associated with the second measurement identity.

83. An apparatus as claimed in claim 82, wherein the indication of the second measurement identity comprises the second measurement identity.

84. A computer program comprising instructions for causing an apparatus to perform at least the following:
establishing a connection towards a user equipment, UE, via a source primary cell;
providing the UE a source primary cell measurement configuration;
determining a condition to access a target primary cell of a secondary cell group of a target secondary node associated with a conditional handover towards a target master node;
generating a measurement identity to be associated, in an updated source primary cell measurement configuration, with the condition to access the target primary cell of a secondary cell group of a target secondary node associated with a conditional handover towards a target master node;
including, in an updated source primary cell measurement configuration, the generated measurement identity and the condition to access the target primary cell of the secondary cell group;
transmitting the updated source primary cell measurement configuration to the user equipment.

85. An apparatus comprising;
at least one processor; and
at least one memory including computer program code,
the at least one memory storing instructions that, when executed by the at least one processor, cause the apparatus at least to:
establish a connection towards a source master node;
receive, from the source master node, at least one measurement configuration containing a condition to access a target primary cell of a secondary cell group of a target secondary node associated with a conditional handover towards a target master node; and
create at least one measurement variable for the received at least one measurement configuration.

86. An apparatus as claimed in claim 85, wherein the at least one measurement configuration is a source primary cell measurement configuration.

87. An apparatus as claimed in claim 86, wherein creating at least one measurement variable for the received at least one measurement configuration comprises updating at least one measurement variable associated with a source primary cell to include a measurement identity associated with the condition to access a target primary cell of a secondary cell group.

88. An apparatus as claimed in claim 87, the at least one memory storing instructions that, when executed by the at least one processor, cause the apparatus at least to:
receive an indication to maintain, after application of a target primary cell measurement configuration, measurement information associated with the condition to access the target primary cell of a secondary cell group that is associated with the measurement identity, for evaluation of the condition to access the target primary cell of a secondary cell group that is associated with a second measurement identity in the target primary cell measurement configuration.

89. An apparatus as claimed in claim 88, wherein the indication comprises the second measurement identity.

90. An apparatus as claimed in claim 88, the at least one memory storing instructions that, when executed by the at least one processor, cause the apparatus at least to use the maintained measurement information for evaluation of the condition to access the target primary cell of a secondary cell group that is associated with the second measurement identity in the target primary cell measurement configuration.

91. An apparatus as claimed in claim 85, wherein the at least one measurement configuration comprises a target primary cell measurement configuration.

92. An apparatus as claimed in claim 91, wherein creating the at least one measurement variable comprises creating at least one independent measurement variable for the target primary cell measurement configuration.

93. An apparatus as claimed in claim 91, the at least one memory storing instructions that, when executed by the at least one processor, cause the apparatus at least to:
receive an indication to maintain, after application of the target primary cell measurement configuration, measurement information for evaluation of the condition to access a target primary cell of a secondary cell group.

94. An apparatus as claimed in claim 93, wherein the indication comprises a flag.

95. An apparatus as claimed in claim 93, the at least one memory storing instructions that, when executed by the at least one processor, cause the apparatus at least to use the maintained measurement information for evaluation of the condition to access the target primary cell of a secondary cell group after application of the target primary cell measurement configuration.

96. A method comprising:
establishing a connection towards a source master node;
receiving, from the source master node, at least one measurement configuration containing a condition to access a target primary cell of a secondary cell group of a target secondary node associated with a conditional handover towards a target master node; and
creating at least one measurement variable for the received at least one measurement configuration.

97. A method as claimed in claim 96, wherein the at least one measurement configuration is a source primary cell measurement configuration.

98. A method as claimed in claim 97, wherein creating at least one measurement variable for the received at least one measurement configuration comprises updating at least one measurement variable associated with a source primary cell to include a measurement identity associated with the condition to access a target primary cell of a secondary cell group.
